(19) United States
(12) Patent Application Publication
(10) Pub. No.: US 2008/0032011 A1
(43) Pub. Date: Feb. 7, 2008

(54) Flavored and Edible Colored Fluids for Printing on Edible Substrates and Precision Deposition Thereof

(75) Inventors: Scott Liniger, Maryville, IL (US); Andrea Hutchison, Saint Louis, MO (US)

Correspondence Address: MICHAEL BEST & FRIEDRICH LLP, 100 E WISCONSIN AVENUE, Suite 3300, MILWAUKEE, WI, 53202, US

(73) Assignee: SENSIENT COLORS INC., St. Louis, MO (US)

(21) Appl. No.: 11/770,678

(22) Filed: Jun. 28, 2007

Related U.S. Application Data
(63) Continuation-in-part of application No. PCT/US2006/005777, filed on Feb. 17, 2006.
(60) Provisional application No. 60/696,045, filed on Jul. 1, 2005.
(60) Provisional application No. 60/816,943, filed on Jun. 28, 2006.

(51) Int. Cl. A23L 1/22; A23L 1/27

(52) U.S. Cl. 426/250; 426/302; 426/303

(57) ABSTRACT

A method of imparting flavor to an edible substrate by precision depositing a first food grade flavored fluid onto a surface of an edible substrate. A method of providing a flavored image on an edible substrate by ink jet printing a food grade colored fluid, where the food grade colored fluid includes a food grade dye, a food grade glycol, and a surface tension modifier to create an image and spraying a food grade flavored fluid onto the edible substrate. In addition, a method of providing a flavored image on an edible substrate by ink jet printing a food grade colored fluid to create an image and spraying a food grade flavored fluid comprising a food grade flavor and a food grade glycol onto the edible substrate.

### CROSS-REFERENCE TO RELATED APPLICATIONS

This application claims priority to U.S. Provisional Application No. 60/816,943, filed Jun. 28, 2006, and PCT Application No. PCT/US2006/005777, filed Feb. 17, 2006, which claims priority to U.S. Provisional Application No. 60/696,045, filed Jul. 1, 2005, the subject matter of each of which is hereby fully incorporated by reference. To the extent there are any inconsistencies or discrepancies between the applications and the present application, the present application shall control.

### BACKGROUND

Ink-jet printing has the potential to revolutionize the food industry by providing a novel way to apply ink-jettable fluids to the surfaces of food items. In addition, a way to precision deposit edible flavored and colored fluids to the surfaces of food items is sought. Specifically, this invention provides an economical and efficient way to impart flavor and color to edible substrates using ink-jet ink and precision deposition technology.

### SUMMARY

In one aspect, a method of imparting flavor to an edible substrate by precision depositing a first food grade flavored fluid onto a surface of an edible substrate is provided.

In another aspect, a method of providing a flavored image on an edible substrate by ink jet printing a food grade colored fluid, where the food grade colored fluid includes a food grade dye, a food grade glycol, and a surface tension modifier to create an image and spraying a food grade flavored fluid onto the edible substrate is provided.

In a further aspect, a method of providing a flavored image on an edible substrate by ink jet printing a food grade colored fluid to create an image and spraying a food grade flavored fluid comprising a food grade flavor and a food grade glycol onto the edible substrate is provided.

Other aspects will become apparent by consideration of the detailed description and accompanying drawings.

### BRIEF DESCRIPTION OF THE DRAWINGS

FIG. 1 is a frontal view of a sprayer;

FIG. 2 is a side view of the sprayer in FIG. 1 illustrating a spray pattern;

FIG. 3 is a first configuration of a spraying system including the sprayer of FIG. 1;

FIG. 4 is a second configuration of a spraying system including the sprayer of FIG. 1;

FIG. 5 is the sprayer of FIG. 1 mounted at an angle; and

FIG. 6 shows two control signals to operate a spraying system.

### DETAILED DESCRIPTION

Described below are food grade flavored fluids for use in printing on edible substrates, methods for applying the food grade flavored fluids directly to edible substrates, and edible substrates having the flavored fluids applied thereto. The food grade flavored fluids are typically made from food grade flavors and glycols and optionally water and/or glycerine. The food grade flavored fluids have characteristics that render them suitable for printing directly onto the surfaces of a variety of edible substrates. Formulations of the present invention should be or have at least one of the following: food grade ingredients; compatibility with the food surfaces onto which they will be applied; and properties (e.g., viscosities, surface tensions, smear resistance, solubilities, drying times) that make them suitable for use with ink-jet printers. The food grade flavored fluids are suitable for use with a variety of ink-jet printers, such as Continuous Ink Jet (CIJ), prop-on-Demand Valve (DoD Valve), Drop-on-Demand Piezo-Electric (DoD Piezo) and Thermal Ink Jet (TIJ). In particular, the food grade flavored fluids are suitable for printing with a variety of piezo and thermal printheads.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

As used herein, “food grade” means that up to specified amounts of the flavored fluids or individual ingredients making up the flavored fluid can be ingested by a human without generally causing deleterious health effects. Therefore, in order to meet the standard of a “food grade” flavored fluid, the flavored fluid should be free or substantially free of ingredients that generally cause deleterious health effects when ingested by a human. When such ingredients are present, e.g., in trace amounts through contamination, those ingredients should be present in amounts below those that would result in the deleterious health effects. Examples of food grade ingredients include those ingredients “generally recognized as safe” (“GRAS”) by the United States Food and Drug Administration (“FDA”) and flavors approved by the FDA for use in foods for human consumption. In particular, food safe ingredients include those ingredients listed as approved under 21 C.F.R. §§ 172.510, 172.515, 172.520, 172.530, 172.535, 172.575, 172.580 and 172.585.

A wide variety of edible substrates may be employed. As used herein, “edible substrate” or “substrate” includes any material suitable for consumption that is capable of having a flavor disposed thereon. Examples of edible substrates onto which the food grade flavored fluids may be printed include snack chips (e.g., sliced potato chips), fabricated snacks (e.g., fabricated chips such as tortilla chips, potato chips, potato crisps), extruded snacks, cookies, cakes, chewing gum, candy, various bread products (e.g., biscuits, toast, buns, bagels, and tortillas), fruit, dried fruit, beef jerky, crackers, pasta, hot dogs, sliced meats, cheese, pancakes, waffles, dried fruit film, breakfast cereals, toaster pastries, ice cream cones, ice cream, gelatin, ice cream sandwiches, ice pops, yogurt, desserts, cheese cake, pies, cup cakes, English muffins, pizza, pies, meat patties, fish sticks, chocolate, hard candy, iced cakes and cookies, marshmallows, muffins, pellet gum, pretzels, processed fruit snacks, pudding, taffy, and vanilla wafers. Additional examples of edible substrates may include, but are not limited to, pharmaceutical applications and pet food applications (e.g., pet treats, snacks, and food). Although any substrate may be combined with any food grade flavored fluid, some substrates may be more compatible than others with a particular food grade flavored fluid. In one embodiment, the edible substrate excludes edible films.

The surface of the edible substrate onto which the food grade flavored fluids are applied may be a porous surface which facilitates the absorption of the food grade flavored fluids by the surface, hastening drying. As used herein, the term “porous surface” is intended to include any surface having sufficient porosity to allow the food grade flavored fluids to be at least partially absorbed. The food grade flavored fluids may also be applied to nonporous edible surfaces, including gelcapsules, gelatin-based roll-ups and other semi to nonporous materials. An optional drying step may be employed when applying to nonporous edible substrates, after the flavored fluid has been applied. Although the above substrates are typically associated with human consumption, it should be understood that any substrate fit for human or animal consumption may be used. Additional examples may include dog bones and dog biscuits.

The food grade flavored fluids may comprise food grade glycol, which acts as a solvent and may account for a large part of the flavored fluid. For example, the food grade glycol may account for at least about 10 wt. % of the flavored fluid. This includes embodiments where the food grade glycol accounts for at least about 25 wt. % of the flavored fluid, further includes embodiments where the food grade glycol accounts for at least about 40 wt. % of the flavored fluid, still further includes embodiments where the food grade glycol accounts for at least about 70 wt. % of the flavored fluid, and even further includes embodiments where the food grade glycol accounts for at least about 85 wt. % of the flavored fluid. Examples of the food grade glycol include 1,2-propanediol, propylene glycol, and combinations thereof. Optionally, food grade thickeners such as sugar syrup, potassium tricitrate, hydroxypropyl methylcellulose, carboxymethylcellulose (e.g., Akucell AF1705 from Akzo Nobel), and hydroxypropylcellulose (e.g., Klucel EF from Hercules Inc.) may be used in addition to the food grade glycols or as a partial or complete replacement for the food grade glycols in the flavored fluid.

Glycerine, water, or a mixture of glycerine and water, may optionally be used as co-solvents along with the food grade glycol. Glycerine provides low volatility and may assist in solubilizing some of the food grade flavors. As such, glycerine helps prevent the food grade flavors from solidifying out of solution, crusting onto and clogging jetting nozzles. When glycerine is used as a co-solvent, it is typically present in an amount of at least about 1 wt. % of the food grade flavored fluid. This includes embodiments where glycerine is present in an amount of at least about 10 wt. %, further includes embodiments where glycerine is present in an amount of at least about 20 wt. %, still further includes embodiments where the glycerine is present in an amount of at least about 30 wt. %, and even further includes embodiments where the glycerine is present in an amount of at least about 45 wt. %. The amount of glycerin present, if any, will depend on a variety of factors, including the extent to which the food grade flavors are soluble in the food grade glycols. Thus, some of the flavored fluids may contain a relatively small amount of glycerine (e.g. about 2 to 10 wt. %) and others may contain a larger amount of glycerine (e.g. about 30 to 45 wt. %). In still other embodiments, glycerine is present in intermediate quantities (e.g. about 12 to 18 wt. %). In one exemplary embodiment, the food grade flavored fluids contain at least about 70 wt. % 1,2-propanediol, glycerine or a mixture thereof.

The food grade flavored fluids may comprise up to about 90 wt. % water, depending upon the type of ink jet method employed. The food grade flavored fluids may be prepared with a relatively high water content. For example, in some embodiments the flavored fluids may contain at least about 50 wt. % water. This includes embodiments where the flavored fluids contains at least about 65 wt. % water, and further includes embodiments where the flavored fluids may contain at least about 75 wt. % water. Food grade flavored fluids having a relatively high water content are particularly suited to valve jet printing methods. In one exemplary embodiment, the food grade flavored fluid comprises about 50 to 90 wt. % water.

The food grade flavored fluids may also be prepared with a low water content. For example, in some embodiments the flavored fluids may contain no more than about 35 wt. % water. This includes embodiments where the flavored fluids contain no more than about 20 wt. % water, and further includes embodiments where the flavored fluids contain no more than about 5 wt. % water. The food grade flavored fluids may be free of or substantially free of water, e.g., having a water content of no more than about 1 wt. %. In these compositions, water can be added, water may be due solely or partially to water absorbed from the air under humid conditions and/or water may be introduced as an impurity or minor component of one of the solvents or additives that make up the flavored fluids. It is advantageous to limit the amount of water present in the flavored fluids because a high water content tends to decrease the viscosity of the fluids, rendering them less suitable for use in some printing applications, such as ink-jet printing applications where elevated jetting temperatures are used. In one exemplary embodiment, the food grade flavored fluids contain about 25 to 95 wt. % 1,2-propanediol, about 3 to 40 wt. % glycerine and no more than about 35 wt. % water.

The food grade flavors used to produce the food grade flavored fluids may be synthetic or artificial flavors, natural flavors or any mixture thereof. The food grade flavors may include any flavors which are soluble in at least one of a food grade glycol, glycerine, water, or mixtures thereof. Examples of suitable flavors include almond, amaretto, apple, green apple, apple-cherry-berry, apple-honey, apricot, bacon, balls of fire, banana, barbeque, beef, roast beef, beef steak, berry, berry blue, birch beer/spruce beer, blackberry, bloody mary, blueberry, boysenberry, brandy, bubble bum, butter, butter pecan, buttermilk, butterscotch, candy corn, cantaloupe, cantaloupe lime, caramel, carrot, cassia, caviar, celery, cereal, champagne, cherry, cherry cola, cherry maraschino, wild cherry, black cherry, red cherry, cherry-cola, chicken, chocolate, chocolate almond, cinnamon spice, citrus, citrus blend, citrus-strawberry, clam, cocoa, coconut, toasted coconut, coffee, coffee almond, cola, cola-vanilla, cookies & cream, cool, cotton candy, cranberry, cranberry-raspberry, cream, cream soda, dairy type cream, creme de menthe, cucumber, black currant, dulce de leche, egg nog, pork fat, type fat, anchovy fish, herring fish, sardine fish, frankfurter, fiery hot, fried garlic, sautéed garlic, gin, ginger ale, ginger beer, graham cracker type, grape, grape grapefruit, grapefruit-lemon, grapefruit-lime, grenadine, grill, guarana, guava, hazelnut, honey, hot, roasted honey, ice cream cone, jalapeno, key lime, kiwi, kiwi-banana, kiwi-lemon-lime, kiwi-strawberry, kola champagne, lard type, lemon, lemon custard, lemonade, pink lemonade, lemon-lime, lime, malt, malted milk, mango, mango-pineapple, maple, margarita, marshmallow, meat type, condensed milk, cooked milk, mint, mirepoix, mocha, mochacinna, molasses, mushroom, sautéed mushroom, muskmelon, nectarine, neopolitan, green onion, sautéed onion, orange, orange cordial, orange creamsicle, orange crème, orange peach mango, orange strawberry banana, creamy orange, mandarin orange, orange-passion-guava, orange-pineapple, papaya, passion fruit, peach, peach-mango, peanut, roasted peanut, pear, pecan danish type, pecan praline, pepper, peppermint, pimento, pina colada, pina colada/pineapple-coconut, pineapple, pineapple-orange, pistachio, pizza, pomegranate, pork fat type, baked potato, prune, punch, citrus punch, tropical punch, cherry fruit punch, grape punch, raspberry, black raspberry, blue raspberry, red raspberry, raspberry-blackberry, raspberry-ginger ale, raspberry-lime, roast type, root beer, rum, sangria, sarsaparilla, sassafras, sausage, sausage pizza, savory, seafood, shrimp, hickory smoke, mesquite smoke, sour, sour cream, sour cream and onion, spearmint, spicy, strawberry, strawberry margarita, jam type strawberry, strawberry-kiwi, burnt sugar, sweet, supersweet, sweet & sour, tallow, tamarind, tangerine-lime, tangerine, tea, tequila type, toffee, triple sec, tropical fruit mix, turkey, tutti frutti, vanilla, vanilla cream, vanilla custard, french vanilla, vegetable, vermouth, vinegar, balsamic vinegar, watermelon, whiskey, wildberry, wine, and yogurt. Other examples of flavors are found in 21 C.F.R. §§ 172.510, 172.515, 172.520, 172.530, 172.535, 172.575, 172.580 and 172.585, which are hereby fully incorporated by reference. A variety of food grade flavors are commercially available from Sensient Flavors Inc. in Indianapolis, Ind., Givaudan SA in Cincinnati, Ohio, and International Flavors & Fragrance in New York, N.Y.

The relative amount of the food grade flavors used in the food grade flavored fluids may vary depending on the desired flavor and the intensity of the flavor. In some embodiments, the food grade flavored fluids will typically contain at least about 0.1 wt. % food grade flavor which includes other embodiments containing at least about 0.5 wt. %. In some embodiments, the flavored fluids contain less than about 20.0 wt. %, in others less than about 10.0 wt. %, and in others less than about 5.0 wt. %. This includes embodiments where the flavored fluids contain about 0.5 to 7.5 wt. %, and further includes embodiments where the flavored fluids contain about 0.5 to 5 wt. % food grade flavor. Preferably the flavored fluids contain about 0.1 to 10.0 wt. % food grade flavor.

In addition to the food grade flavors and glycols and any optional glycerine and/or water co-solvents, the food grade flavored fluids may comprise other food grade additives such as surface tension modifiers, thickening agents, antioxidants, preservatives, buffering agents, anti-microbial agents, vitamins, and nutrients. These additional additives will typically be present only in small quantities. For example, these additional food grade additives may be present in amounts of no more than about 10 wt. % of the flavored fluid. This includes embodiments where the food grade additives are present in amounts of no more than about 5 wt. % and further includes embodiments where the food grade additives are present in amounts of no more than about 3 wt. %. Examples of additives include sodium dioctyl sulfosuccinate, sodium laurel sulfate, sodium laureth sulfate, sugar syrup, potassium tricitrate, hydroxypropyl methylcellulose, carboxymethylcellulose (e.g., Akucell AF1705 from Akzo Nobel), hydroxypropylcellulose (e.g., Klucel EF from Hercules Inc.), butylated hydroxyanisole (BHA), butylated hydroxytoluene (BHT), n-propyl gallate (PG), ascorbic acid (Vitamin C), sodium ascorbate, calcium ascorbate, tocopherols (e.g., extracted from cereals, oilseeds, nuts, and vegetables), spice extracts (e.g., clove, sage, oregano, rosemary, and allspice), methylparaben, propylparaben, sodium benzoate, and citric acid. Additional additives can be found in 21 C.F.R. § 172.5, which is hereby fully incorporated by reference. Additives may be used individually or in combination.

Food grade flavor fluid additives may also include synthetic dyes, natural dyes, pigments, pearlescent pigments, or combinations thereof. As used herein, the term “dye” denotes dyes which are soluble in water and/or in the other co-solvents, comprising substantial amounts of glycols and/or glycerine, employed in the present flavored fluids. Suitable synthetic dyes for use in the present flavored fluids include food grade FD&C dyes, such as FD&C Red #3, FD&C Red #40, FD&C Yellow #5, FD&C Yellow #6, FD&C Blue #1, and FD&C Green #3, and their corresponding lakes. Suitable natural dyes include turmeric oleoresins, caramel color, cochineal extracts including carminic acid and its corresponding lake, gardenia extracts, beet extracts, and other natural colors derived from vegetable juices, and chlorophyll-containing extracts, such as nettle extract, alfalfa extract and spinach extract. Anthocyanins are another class of food grade dyes that may be used in the flavored fluids. The anthocyanins may be derived from a variety of plant sources, including fruit juices, elderberries, black currants, chokeberries, vegetable juices, black carrots, red cabbage, grapes and grape skins, and sweet potatoes. The use of a pearlescent pigment confers the ability to impart improved pearlescence to edible articles. The pearlescent pigment should be capable of meeting all government approved requirements for human consumption. Suitably, these pearlescent pigments include those pigments having a mica, titanium oxide or iron oxide base. In one embodiment, the pearlescent pigment comprises a micaceous pearlescent pigment, such as those containing mica coated with titanium dioxide, iron oxide, and combinations thereof. Other examples of pearlescent pigments include, but are not limited to, those available under the trade name Candurin® from Merck KGaA and those set forth in PCT publication No. WO 00/03609, the entire disclosure of which is incorporated herein by reference. A non-limiting list of suitable Candurin® pearlescent pigment products include the following: silver fine, silver sheen, silver lustre, silver sparkle, gold shimmer, red shimmer, blue shimmer, green shimmer, gold sheen, light gold, gold lustre, brown amber, orange amber, red amber, red lustre, and red sparkle. Other examples of pearlescent pigments include, but are not limited to, those available under the trade names Bi-Lite®, Cellini®, Chroma-Lite®, Cloisonne®, Cosmica®, Desert Reflections®, Duocrome®, Flamenco®, Gemtone®, Mearlite®, Mearlmaid®, Pearl-Glo®, Reflecks®, Shinju®, and Timica® from the BASF Group (formerly Engelhard Corporation) and those set forth in U.S. Pat. No. 6,627,212 and U.S. Patent Publication No. 2005-0257716, each of which is hereby fully incorporated by reference. Other pearlescent pigments are based on platy titanium dioxide which imparts a distinctive color. Additional pearlescent pigments that may be utilized are available from HebeiOxen (China). Examples of pearlescent pigments from HebeiOxen include, but are not limited to, pigments from the anatase series, including bright silver, fine silver, satin silver, metal silver, intense silver, and super bright silver; pigments from the gold luster series, including, bright brass gold, satin super gold, fine gold, bright orange, flash gold, bright violet gold, bright rose red, satin khaki, and bright khaki; pigments from the rutile series, including, bright silver, fine silver, satin silver, satin gold, bright gold, satin red, bright red, bright red orange, bright violet, satin violet, satin blue, bright blue, satin green, bright green, satin violet, bright violet; pigments from the metal luster series, including, bright brown yellow, bright red, bright violet red, satin violet red, bright violet, satin violet, satin red, bright green, bright brown, metal brown yellow, bright orange red, and satin orange red; pigments from the dyeing series, including satin gray, bright blue, bright yellow, bright green, bright peachblow, and bright violet red; pigments from the polychrome series, including bright super blue, bright blue, bright blue violet, bright blue green, bright green blue, bright green, and bright green yellow; pigments from the weather resistance series, including bright silver, satin silver, bright red, bright violet red, bright blue, and bright green; pigments from the superstrength weatherable series, including blue green, bright green, bright violet, bright blue violet red, and yellow green; pigments from the 9000 series, including bright black and satin black; pigments from the silver white series, including crystal silver, and crystal sparkling silver; pigments from the interference series, including sparkling gold, glowing red, amethyst violet, ultra sparkling blue, and ultra sparkling green; pigments from the gold series, including brass gold; pigments from the iron series, including brown yellow and violet red. Other examples of pearlescent pigments include, but are not limited to, those available under the trade name Covapearl® from Sensient. A non-limiting list of suitable Covapearl® pearlescent pigment products include the following: green 737, light dore 235, antique 236, bright 933, spark silver 937, satin 931, silver 939, red 339, pink 433, and blue 635. Other examples of pearlescent pigments may be found in U.S. Pat. Nos. 5,611,851 and 6,902,609 and U.S. Patent Publication No. 2005-0147724, each of which is hereby fully incorporated by reference. Other pearlescent pigments are based on iron oxide based pigments available from HebeiOxen.

Although the relative amount of the food grade dyes and pigments used in the food grade flavored fluids may vary depending on the desired color, shade and intensity, the food grade flavored fluids, when used, will typically comprise at least about 0.01 wt. % (dsb) food grade dye and/or pigment, in others at least about 5.0 wt. % (dsb) food grade dye and/or pigment, and in yet others at least about 10.0 wt. % (dsb) food grade dye and/or pigment. Dyes and/or pigments are not required. In some embodiments, the flavored fluids comprise less than about 10.0 wt. % (dsb) food grade dye and/or pigment, in others less than about 7.5 wt. % food grade dye and/or pigment, and in yet others less than about 5.0 wt. % (dsb) food grade dyes and/or pigments. This includes embodiments where the food grade flavored fluids contain about 0.5 to 7.5 wt. % (dsb), and further includes embodiments where the food grade flavored fluids contain about 0.5 to 5 wt. % (dsb) food grade dye and/or pigment. In another embodiment, the food grade flavor fluid excludes chromic compounds comprising polymerized polyacetylenes.

Additives to flavored fluids may further include lower alcohols (i.e. alcohols having one to six carbon atoms), such as isopropanol, ethanol, n-butyl alcohol, and i-butyl alcohol, or mixtures thereof. The lower alcohols may be used as surface tension modifiers and will generally be present in amounts of no more than about 10 wt. % and more typically about 1 to 5 wt. %. This includes embodiments where the flavored fluids may contain no more that about 3 wt. % lower alcohol and further includes embodiments where the flavored fluids may be substantially free of lower alcohol, such as isopropanol, i.e., contain no more than about 0.5 wt. % lower alcohol.

For some applications it is desirable, but not required, to exclude certain additives. For example, some food grade flavored fluids in accordance with this disclosure may be free of or substantially free of one or more of the following additives: glycol ethers, polyol monoethers, urea, tetraalkylammonium cations (e.g. tetramethylammonium cations), alkanol ammonium compounds (e.g., monoethanol ammonium compounds, diethylammonium compounds, or triethanol ammonium cations), cationic amide compounds (e.g., protonated formamide), silica, sebacyl chlorides, binding agents and film-forming agents. A food grade flavored fluid is “substantially free of” an additional food grade additive if the flavored fluid contains no more than about 0.5 wt. % of the additional food grade additive. In some instances, the food grade flavored fluid contains no more than about 0.2 wt. % of a given additive. In still other instances the food grade flavored fluid contains no more than about 0.1 wt. % of a given additive. For example, it may be desirable to have food grade flavored fluids which contain no more than about 0.05 wt. % binding agents and/or film-forming agents, such as polymers, gum arabic, hydrocolloids, xanthum gum, waxes, alginates and polysaccharides.

For some applications, it is generally desirable for the food grade flavor fluids to have a high degree of purity. Impurities can affect the jettability of the flavored fluids and/or the lifetimes of printer parts. Inorganic salts, such as sodium chloride and sodium sulfate, are examples of common impurities that may be particularly detrimental to flavor fluids. Fluids having elevated salt contents, whether from the flavor component or elsewhere, may be corrosive to printer parts and lead to shorter printer lifetimes. Therefore, it is typically advantageous to prepare flavored fluids having a low inorganic salt content, or at least a low chloride and/or sulfate ion content. In some exemplary embodiments, the flavored fluids contain an inorganic salt content, and more specifically in some instances a chloride and/or sulfate ion content, of no more than about 0.5 wt. %. This includes embodiments in which the flavored fluids contain an inorganic salt content, or at least a chloride and/or sulfate ion content, of no more than about 0.2 wt. % and desirably no more than about 0.1 wt. %. The salt (e.g. chloride and or sulfate ion) impurity level in the food grade flavor fluid will desirably be no more than about 1000 ppm. In some embodiments, the impurity level will be no more than about 500 ppm and in still other embodiments the impurity level will be no more than about 100 ppm. In some instances it may be possible for the flavored fluids to include higher levels of certain less corrosive salts provided the levels of chlorides and/or sulfates in the flavor fluids remains low. Thus, in certain embodiments, the inorganic salt content and impurity limits cited above may be interpreted to refer specifically to chloride and/or sulfate ion content in the flavored fluids. Other examples of detrimental impurities include surface oils, bulk oils, and suspended solids having particle diameters greater than 5 μm.

For some applications (e.g., ink jet printing), it is also generally desirable for the food grade flavored fluids to have a viscosity of at least about 8 centipoise (cps), in others at least about 12 cps, and in yet others about 14 cps at a particular temperature (e.g., at the jetting temperature at which the printing is to take place). In some embodiments, the flavored fluids have a viscosity of less than about 14 cps, in others less than about 12 cps, and in yet others less than about 8 cps. This includes embodiments where the flavored fluids have a viscosity of 8 to 12 cps at the desired jetting temperature. Some ink-jet printers are designed to be operated at ambient temperatures (i.e. about 25° C.). Other ink-jet printers are designed for operation at elevated print head temperatures of at least 80° C. or higher. For example, an ink-jet printer may operate at jetting temperatures ranging from about 50 to 70° C. The flavored fluids may have these viscosities at the prescribed temperatures when they are used in non-ink jet applications such as precision deposition. The formulation of the flavored fluids, including the ratio of food grade glycol to glycerine and the amount of water present, may be desirably controlled to provide a suitable viscosity for the intended jetting temperature. For example, a flavored fluid may be tailored to have a viscosity of about 8 to 14 cps at a jetting temperature of 60° C. However, the viscosity of these flavored fluids may be significantly higher at ambient temperatures. For example, the flavored fluids may have viscosities of about 35 to 65 cps at 25° C. Alternatively, a flavored fluid may be tailored to have a viscosity of about 8 to 14 cps at a jetting temperature of 25° C. The preferred viscosity of a flavored fluid may be dictated by the ink jet printing method. For example, flavored fluids for piezo ink jet printers typically have viscosities ranging from about 8 to 14 cps at jetting temperature. In contrast, flavored fluids for valve jet printer typically have viscosities ranging from about 1 to 5 cps at jetting temperature.

It has been discovered that food grade flavored fluids exhibiting Newtonian viscosities perform favorably. Thus, in some embodiments, the flavored fluids have Newtonian viscosities. Specifically, the flavored fluids may exhibit a Brookfield viscosity that changes by no more than about 2 cps with a shear rate increase from about 15 to 45 rpm at a temperature selected from a temperature in the range of 20 to 70° C. (e.g., 60° C.). In some embodiments, the flavored fluids exhibit a Brookfield viscosity that changes by no more than about 1 cps and in still other embodiments, the flavored fluids exhibit a Brookfield viscosity that changes by no more than about 0.5 cps with a shear rate increase from 15 to 45 when measured at a temperature selected from a temperature in the range of 20 to 70° C. (e.g., 60° C.).

In ink jet ink applications, the surface tension of the food grade flavored fluids may vary over a relatively wide range, provided it is suitable to allow the flavored fluids to be jetted through an ink-jet printing head and printed onto the surface of an edible substrate. In some applications (e.g., for precision deposition or ink jet), the flavored fluids will have surface tensions of at least about 20 dynes per cm at 25° C., in others at least about 35 dynes per cm at 25° C., and in yet others at least about 60 dynes per cm at 25° C. In some embodiment, the flavored fluids will have surface tensions less than about 60 dynes per cm at 25° C., in others less than about 40 dynes per cm at 25° C., and in yet others less than about 30 dynes per cm at 25° C. This includes embodiments where the flavored fluids have surface tensions of 35 to 60 dynes per cm at 25° C. and further includes embodiments where the flavored fluids have surface tensions of 28-32 dynes/cm.

To prevent clogging of ink-jet printer nozzles it is advantageous to provide food grade flavored fluids having reduced particle content. Particle content may be characterized by the silt density index (SDI) of the fluid. SDI values provide a measure of particle content that relates the rate of membrane clogging to the quantity of particulate matter present in a fluid. SDI values may be measured as follows: two aliquots of equal volume of the fluid to be tested are poured sequentially into a filter and the time required for each aliquot to pass through the filter is measured. The SDI is provided by the ratio of the time it takes the first aliquot to pass through the filter to the time it takes the second aliquot to pass through the filter. A higher SDI value indicates a fluid having a lower particle content. A fluid that has no buildup on the filter, and therefore very little particle content, will have an SDI value of 1. Unless otherwise noted, an SDI value for a given liquid sample may be measured at any arbitrary time after the sample is prepared without requiring any particular set of processing conditions to have been preformed prior to the measurement. SDI temperature accelerated conditions may be varied according to the jetting temperature and/or heat stability of the flavored component. The SDI values of the flavored fluids may also be beneficial for use in precision deposition applications.

The food grade flavored fluids desirably have relatively low particle contents. As such, some of the flavored fluids are solutions of one or more food grade flavors that filter through a filter having a size of at least about 0.2 μm and in others at least about 1 μm. In some embodiments, the flavored fluids filter through a filter having a size less than about 5 μm. The food grade flavored fluids provided herein include fluids having an SDI of at least about 0.5. In certain embodiments the flavored fluids have an SDI of at least about 0.75. This includes embodiments where the flavored fluids have an SDI of at least about 0.9 and still further includes embodiments where the flavored fluids have an SDI of at least about 0.95.

Low specific gravity may be advantageous in some applications. In a typical embodiment, the food grade flavored fluids may have a specific gravity of no more than about 1.15. This includes embodiments where the flavored fluids have a specific gravity of no more than about 1.13 and further includes embodiments where the flavored fluids have a specific gravity of no more than about 1.10 (e.g., about 1.00 to 1.10).

The pH values of the food grade flavored fluids are not critical, however it may be advantageous to provide flavored fluids with an apparent pH of at least about 3 and desirably at least about 5 to prevent the flavored fluids from corroding printer parts or precision deposition equipment. Generally, the flavored fluids include those having an apparent pH in the range of about 4 to 9. This includes flavored fluids having an apparent pH in the range of about 5 to 8. Apparent pH values may be read directly from any suitable, commercially available pH meter. Although these apparent pH values may not be interpreted as an index of hydrogen ion potential nor used in equilibrium computations, they are reproducible and useful for qualitative purposes.

Generally, the food grade flavored fluids are made by mixing all ingredients except the flavor component in a food grade container for about 30 to 60 minutes to form a solution. Mixing is generally done under ambient conditions. However, the ingredients may be heated to temperatures less than about 60° C. during the mixing process. If heat is applied during mixing, the resultant solution may be cooled to ambient temperature before proceeding to the next step. In one embodiment, after mixing, the solution is passed through a filter having a size of about 0.2 μm. The flavor component is added to the filtrate, preferably in a fume hood, and the filtrate and flavor component are stirred for about 30 minutes to form the flavored fluid. The flavored fluid is then passed through a filter having a size of about 0.5 μm to 1.0 μm.

The following illustrative embodiments are intended to further exemplify the food grade flavored fluids. These embodiments should not be interpreted as limiting the scope of the flavored fluids disclosed herein.

A food grade flavored fluid comprising a food grade flavor, about 25 wt. % of a food grade glycol, optionally glycerine and optionally water is provided. In this flavored fluid, the food grade glycol and any optional glycerine and water make up at least about 90 wt. % of the flavored fluid, and any water present makes up no more than about 35 wt. % of the flavored fluid.

The above-described flavored fluid may be further defined by a variety of additional ingredients, properties and range limitations to provide a number of different embodiments of the food grade flavored fluids. A few of these embodiments will now be described in more detail.

A food grade flavored fluid comprising about 0.1 to 10 wt. % food grade flavor, about 25 to 95 wt. % food grade glycol, about 1 to 50 wt. % glycerine and no more than about 35 wt. % water is provided. This flavored fluid has a viscosity of about 8 to 14 cps at 60° C.

A food grade flavored fluid comprising a food grade flavor, a food grade glycol, optionally glycerine and optionally water is provided. In this flavored fluid the food grade glycol and any optional glycerine and water comprise at least about 90 wt. % of the flavored fluid and any water present makes up no more than about 35 wt. % of the flavored fluid. The flavored fluid is characterized by a Brookfield viscosity at 60° C. that changes by no more than 2 cps over a shear rate range from about 10 to 45 rpm. In one embodiment, the flavored fluid contains at least about 25 wt. % 1,2-propanediol as the food grade glycol. In another embodiment, the flavored fluid contains at least about 25% propylene glycol. The flavored fluid may have a surface tension of about 35 to 50 dynes per cm at 25° C. and/or a viscosity of about 35 to 65 cps at 25° C.

A food grade flavored fluid comprising a food grade flavor and at least about 25 wt. % food grade glycol is provided. The food grade flavor in the flavored fluid has an inorganic salt content of no more than about 0.5 wt. %. The food grade flavored fluid may optionally include glycerine. In some embodiments, the flavored fluid contains at least about 70 wt. % 1,2-propanediol, glycerine or a mixture thereof. In other embodiments, the flavored fluid contains at least about 70 wt. % propylene glycol, glycerine or a mixture thereof. The flavored fluid may have a viscosity of about 35 to 65 cps at 25° C.

A food grade flavored fluid comprising at least about 40 wt. % food grade glycol is provided. The flavored fluid comprises at least about 0.1 wt. % flavor component. When glycerine is present, the flavored fluid comprises at least about 3 wt. % glycerine. In applications where it is desirable to limit the amount of water present, water may make up no more than about 20 wt. % of the flavored fluid. In other formulations, the water may account for an even smaller fraction of the flavored fluid. For example, any water present may make up no more than about 1 wt. % of the flavored fluid. A specific embodiment of the above-described flavored fluid may contain about 0.1 to 7.5 wt. % of a food grade dye. The food grade dye in the flavored fluid may be FD&C Red #3, FD&C Red #40, FD&C Yellow #5, FD&C Yellow #6, FD&C Blue #1 or a mixture thereof. The flavored fluid may include one or more synthetic food grade dyes having an inorganic salt content of no more than about 0.5 wt. %. The flavored fluid may also contain a food grade natural dye instead of or in combination with one or more synthetic dyes. The flavored fluid may have one or more the following properties: a viscosity of about 8 to 14 cps at 60° C., a surface tension of about 20 to 60 dynes per cm at 25° C., a specific gravity of no more than about 1.13, a silt density index of at least about 0.5, and a Brookfield viscosity at 60° C. that changes by no more than about 2 cps over a shear rate range from about 10 to 45 rpm.

A food grade flavored fluid comprising a food grade flavor and at least about 70 wt. % food grade glycol, glycerine or a mixture thereof is provided. This flavor fluid has a viscosity of about 35 to 65 cps at 25° C. The amount of glycol (e.g., 1,2-propanediol) in the flavored fluid may be substantial. For example, the flavored fluid may contain at least about 40 wt. % glycol. This includes embodiments where the flavored fluid contains at least about 85 wt. % glycol. Glycerine may be present in the flavored fluid in amounts of about 2 to 10 wt. %. Alternatively, glycerine may be present in amounts of about 12 to 30 wt. %. The flavored fluid may further include isopropanol, ethanol or a mixture thereof. Methylparaben, propylparaben or a mixture thereof may also be present in the flavored fluid. Additionally, synthetic dyes, natural dyes, or combinations thereof may be present in the flavored fluid. In applications where a low water content is desirable, the flavored fluid may contain no more than about 20 wt. % water. This includes embodiments where the flavored fluid contains no more than about 1 wt. % water. The flavored fluid may contain one or more synthetic food grade flavors including sour flavor, strawberry flavor, vanilla flavor and balls of fire. The flavored fluid may have one or more of the following properties: a viscosity of about 8 to 14 cps at 60° C., a surface tension of about 35 to 50 dynes per cm at 250° C., a silt density index of at least about 0.5, a specific gravity of no more than about 1.13, or a specific gravity of no more than about 1.10.

A method of applying an edible flavor to a surface of an edible substrate, by ink-jet printing any one of the above-described food grade flavored fluids directly onto the surface of the edible substrate is provided. The ink-jet printing may take place at a range of jetting temperatures. For example, the ink-jet printing may take place at a jetting temperature of about 25 to 75° C. This includes methods of printing where the ink-jet printing takes place at a jetting temperature of about 50 to 70° C. One or more piezoelectric print heads may be used in the printing process.

In addition to, or in conjunction with, printing food grade flavors and flavored fluids onto edible substrates using, for example, the ink-jet ink and valve printing technology set forth above, deposition, and more preferably, precision deposition of food grade flavors and flavored fluids onto food products may be employed. In one embodiment, precision deposition of food grade flavored fluids is accomplished with USMR Micro-Spray Markers available from UNIVERSAL STENCILING & MARKING SYSTEMS (St. Petersburg, Fla.), which is described below as it applies to precision deposition of food grade flavored fluids to edible substrates, or edible substrates having images ink jet printed thereon.

The precision deposition may be used alone to apply one or more food grade flavored fluids to an edible substrate. Additional application of the same or different flavored fluids may be accomplished using the precision deposition technology set forth below. In addition, the printing technology (e.g. ink jet and valve) may be used to apply flavored fluids onto flavored fluids applied using precision deposition. More typically, however, would be the precision deposition of flavored fluids onto the same or different flavored fluids applied using the printing technologies described herein. Various combinations of the precision deposition and printing technologies will be readily ascertainable to those skilled in the art. These combinations will be preferably suited for accomplishing Examples 2 and 5.

Precision deposition can also be used to apply fluids having at least one of a color component, a flavor component, or both onto an image (e.g. those set forth in U.S. application Ser. Nos. 10/601,064 filed Jun. 20, 2003, 10/918,197 filed Aug. 13, 2004 and 11/149,665 filed Jun. 10, 2005, each of which is hereby fully incorporated by reference) or flavor image applied by the printing methods described herein. Those skilled in the art will readily ascertain the various combinations of flavored fluids and colored edible fluids that can be applied through various combinations of printing technology (e.g. ink jet and valve) and the precision deposition methods described herein.

Food grade flavored fluids may be precision deposited onto the surface of an edible substrate. Precision deposition of food grade flavored fluids is accomplished with the use of a USMR Micro-Spray Markers available from UNIVERSAL STENCILING & MARKING SYSTEMS (St. Petersburg, Fla.). For the purposes of the present application, precision deposition means something different than ink jet or valve printing. In other words, precision deposition as used herein is not ink jet or valve printing.

Precision deposition provides the ability to precisely deposit a flavor or sensory experience onto an edible substrate (e.g., processed, snack, savory, sweet, candy, gum, etc.) that enhances the consumer's eating experience. This precision deposition delivers advantages other methods of flavor application do not, including specific area application, less waste and flexibility (e.g., a multi-pack of a product can house a different flavor/sensory experience with each product contained therein).

Flavored fluids can be formulated for a variety of end uses. In one embodiment, the flavored fluid imparts one or more flavors to a substrate in either a random or predetermined pattern using a USMR Micro-Spray Marker. In another embodiment, the flavored fluid enhances the primary flavor of the edible substrate, such as depositing chocolate flavor on a chocolate snack cake. In yet another embodiment, the flavored fluid provides a flavor different from the primary flavor of the edible substrate, such as depositing strawberry flavor on chocolate. In a further embodiment, the flavored fluid provides surprise impact, such as depositing hot or sour flavors on a salty snack.

Examples of the various embodiments include, but are not limited to: precision depositing sweet, sour, hot, spicy or honey flavors on a potato chip; precision depositing strawberry, chocolate or citrus flavors on snack cakes; precision depositing sweet, sour, cool or mint flavors on candy products; precision depositing smoky, barbeque, spicy or wasabi on processed food products; precision depositing a bacon flavor onto a dog treat; precision depositing a cheese flavor onto one-half of a cracker and a garlic flavor onto the other one-half of the cracker; precision depositing a strawberry flavor onto one-third of an ice cream bar, a chocolate flavor onto another one-third of the ice-cream bar, and a vanilla flavor onto the remaining one-third of the ice-cream bar; precision depositing a mystery flavor (e.g., apple flavor) onto a colorless, gelatin-based roll-up; precision depositing fruit flavor onto chocolate; precision depositing mint flavor onto chocolate; precision depositing jalapeno flavor onto tortillas; precision depositing strawberry flavor onto a chocolate chip cookie; precision depositing assorted flavors onto cookies to create a CPG (consumer packaged goods) of assorted flavors; precision depositing pepper flavor onto crackers; precision depositing a second flavor onto ice cream; and precision depositing a second flavor onto the top of yogurt before the cup is sealed (the consumer then mixes the second flavor in, or it could be a surprise flavor).

Using precision deposition, different stripes of flavors, such as strawberry, chocolate or vanilla, are applied to a chocolate cookie. Using precision deposition, stripes of vanilla, chocolate and strawberry are applied to an ice cream sandwich for a Neapolitan effect. Precision deposition is used to control the length and width of the stripes of flavor. Using precision deposition, a stripe(s) of jalapeno flavor is applied to a tortilla.

In some embodiments, the flavored fluids (or flavor images) are used to enhance or alter the flavor of the edible substrate. For example, a strawberry flavor fluid is applied to a snack cake. When the consumer eats the snack cake, he senses the strawberry flavor as part of consuming the edible substrate. In other embodiments, the flavored fluids are used to provide a secondary sensory experience. The consumer licks the flavored fluid off the edible substrate prior to its consumption. The flavored fluid provides a secondary flavor that is separate from any flavor associated with eating the substrate. In yet other embodiments, the flavored fluids are used to provide a secondary flavor and enhance the flavor of the edible substrate.

Food grade colored fluids can be printed through commercially available printing equipment employing printheads manufactured by manufacturers of piezo printheads such as Spectra, Xaar, Hitachi and PicoJet. One example of a printhead which could be used for jetting these fluids is the NovaAAA jetting assembly 256/80 AQ, manufactured by Spectra. Inks successfully jet at frequencies including 1 kHz to 25 kHz. Based on the printhead design and fluid ingredients, fluids may be jettable up to a frequency of 40 kHz. For highest resolution a substrate gap of 1 mm may be desirable. Substrates such as cookies, crackers, breads, marshmallows, and other edible items in a wide variety of shapes and thickness may be jetted.

Food grade flavored fluids may be precision deposited onto the surface of an edible substrate, either before or after an image has been printed onto the edible substrates. Precision deposition of food grade flavored fluids is accomplished with the use of a USMR Micro-Spray Marker available from UNIVERSAL STENCILING & MARKING SYSTEMS (St. Petersburg, Fla.).

In an additional embodiment, the flavored fluids impart a flavor image to the substrate using precision deposition. A flavor image combines taste appeal with visual appeal by depositing flavored fluids having both a flavor component and a color component. One or more flavored fluids can be deposited onto a substrate to produce a variety of images and patterns exhibiting one or more flavors and colors. The flavor component may have a direct correlation to the image, such as the image of a jalapeno pepper having a jalapeno flavor, or be completely unrelated, such as the image of a grape having a cinnamon flavor. In a further embodiment, the flavor components and color components are in separate fluids. Flavored fluids contain one or more flavor components. Colored fluids contain one or more colored components. Food grade colored fluids suitable for producing images on substrates can be found in U.S. application Ser. Nos. 10/601,064 filed Jun. 20, 2003, 10/918,197 filed Aug. 13, 2004 and 11/149,665 filed Jun. 10, 2005, each of which is hereby fully incorporated by reference. The flavor image is produced by precision depositing at least one flavored fluid and printing at least one colored fluid onto a substrate either simultaneously or sequentially. When the fluids are printed and deposited sequentially, either the colored fluid or the flavored fluid may be printed or deposited first. The fluids may be printed and deposited onto the substrate in either a random or predetermined pattern.

Examples of the various embodiments include: precision depositing a strawberry flavor and printing the image of a strawberry onto a cookie; precision depositing a spicy hot flavor and printing the image of a volcano onto a slice of bologna; and precision depositing a sour cream & onion flavor and printing the image of a jalapeno pepper onto a potato chip. Precision deposition may be used to provide a hot or sour spot at the center of a starburst image on a gelatin-based roll-up. Precision deposition enables a hot or sour spot of, e.g., ⅛″ or ¼″. The spot is precisely applied to the image to give the desired size of the spot and the desired location. In another example, the image of a jalapeno pepper is printed on a tortilla and a spot of jalapeno flavor is precision deposited on the image.

In some embodiments, the flavored fluids (or flavor images) are used to enhance or alter the flavor of the edible substrate. For example, a strawberry flavor fluid is applied to a snack cake. When the consumer eats the snack cake, he senses the strawberry flavor as part of consuming the edible substrate. In other embodiments, the flavored fluids (or flavor images) are used to provide a secondary sensory experience. The consumer licks the flavored fluid (or flavor image) off the edible substrate prior to its consumption. The flavored fluid (or flavor image) provides a secondary flavor that is separate from any flavor associated with eating the substrate. In yet other embodiments, the flavored fluids (or flavor images) are used to provide a secondary flavor and enhance the flavor of the edible substrate.

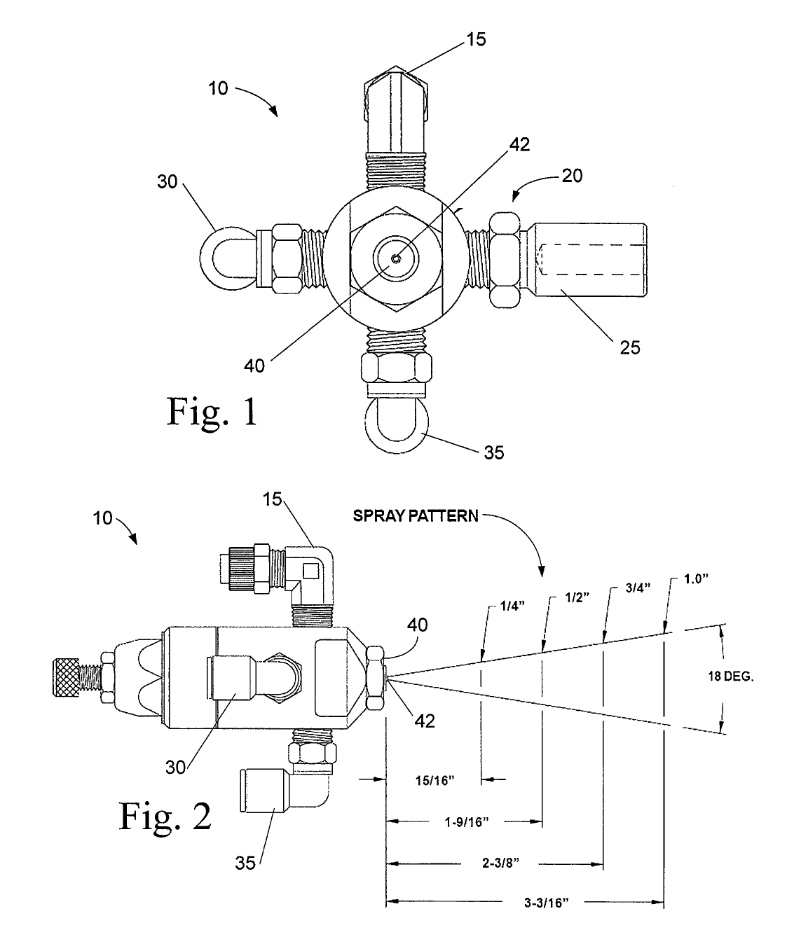

The food grade flavored fluids can be produced to have characteristics that make them suitable for precision deposition onto the edible substrates described above. Formulations of the present invention may have at least one of the following: food grade ingredients, compatibility with the surfaces of the edible substrates onto which they will be applied, and properties (e.g., viscosities, surface tensions, smear resistance, solubilities, and drying times) that make them suitable for use with ink sprayers, such as the USMR Micro-Spray Markers. In particular, the formulations may be suitable for spraying onto edible substrates using the USMR-20AF Micro-Spray Marker with Adjustable Fluid Control (herein referred to as “the spray marker”) illustrated in FIGS. 1-5. It is to be understood that the use of this particular spray marker is proposed only as an example and any other spraying devices capable of precision deposition may be suitable for this invention.

The precision deposition technology may enable a consistent quantity of flavored or colored fluid to be applied to an edible substrate. It also may enable precision in the location of the application, substrate after substrate.

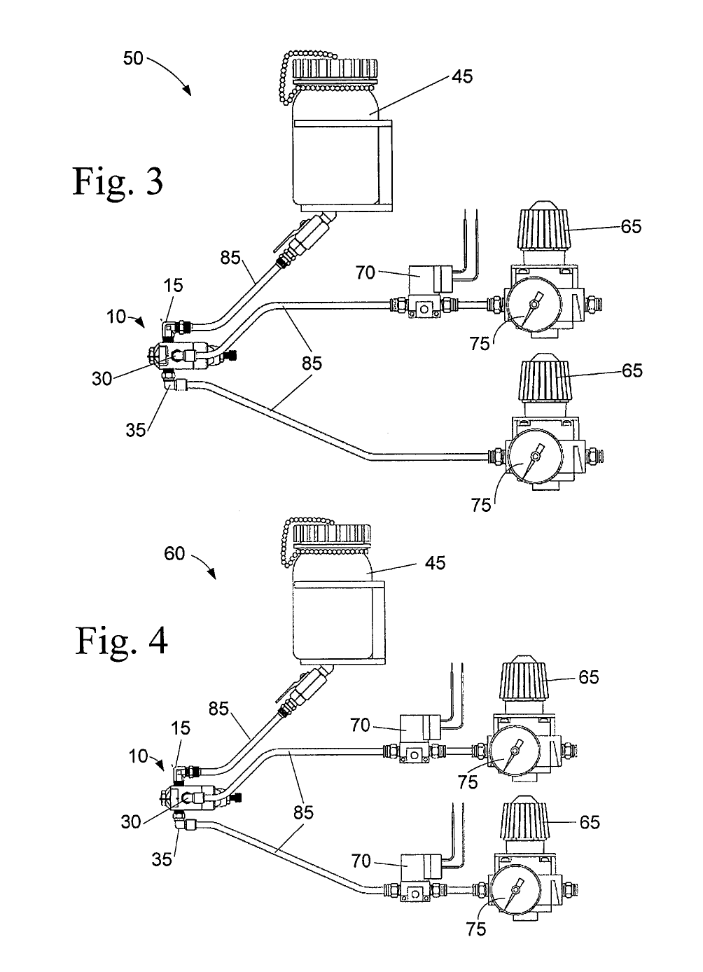

FIG. 1 is a frontal view of a spray marker 10 that includes a liquid receiver 15, a mounting piece 20 with an adaptor 25, a trigger air receiver 30, an atomizer air receiver 35, and a spraying portion 40 having a spraying aperture 42. The liquid receiver 15 is configured to receive food grade flavored fluid from a container 45 generally placed above the spray marker 10 (shown in FIG. 3). The trigger air receiver 30 is configured for the spray marker 10 to receive pressurized air precisely when flavored fluid is to be sprayed onto edible substrates. The atomizing air receiver 35 is also configured to receive compressed air used in the process of spraying flavored fluids onto edible substrates. The mounting piece 20 is configured to receive, or be adapted to, any device (e.g., a bracket, mounting plates, screws, or clamps) suitable to mount the spray marker 10 to a desired location for precision deposition. Particularly shown in FIG. 1 is the adaptor 25, which is suitable to receive a mounting shaft (not shown). Other adapters may also be coupled to the spray marker 10 for mounting purposes. By adjusting the opening of the spraying aperture 42 and/or the air pressure, the volume of the flavored or colored fluid to be deposited can be controlled. Once these parameters are set, the volume can remain consistent.

In general, the spray marker 10 can produce round marks or stripe patterns of flavored fluid based on the mounting characteristics. A deposition system for spraying flavored fluid onto edible substrates may include the spray marker 10 mounted on a static station or on an automated arm. Regardless of the mounting characteristics of the deposition system, applying round marks of flavored fluid is generally characterized by controlling the spray marker 10 with relatively short electrical signals. For example, electrical signals for controlling the spray marker 10 may each include a time duration of 100 milliseconds. Generating electrical signals at this rate usually allows the spray marker 10 to apply about 180 round marks per minute onto edible substrates. Longer time duration electrical signals can be generated to extend the time of flavored fluid application onto edible substrates generating stripe patterns, when the spray marker 10 moves with respect to edible substrates, or round marks with higher concentration of flavored fluid, when the spray marker 10 remains static with respect to edible substrates. In addition, a photoeye or photocell, or other means of triggering, can be used to initiate the depositing sequence.

A deposition system can be configured to include the spray marker 10 above-described to apply flavored fluid under various conditions based on the time duration of electrical signals controlling the spray marker 10 and the type of mounting of the spray marker 10. For example, the spray marker 10 may be mounted in a static position to apply flavored fluid onto various edible substrates moving on a conveyor or endless belt (not shown). It is possible to coordinate the operation of the deposition system with the operation of the conveyor to apply the desired amount of flavored fluid on the each piece of the edible substrates. Another example may include the spray marker 10 being mounted onto an automated arm. In this particular case, the automated arm can transport the spray marker 10 to the particular location of the edible substrate.

FIG. 2 shows the spray marker 10 configured to apply flavored fluid with a round shape characterized by having an adjustable spot size from about 1/16″ to about 2″, particularly from about ⅛″ to about 1″, and more particularly from about ¼″ to about ¾″. The spray marker 10 generally fires perpendicularly with respect to the edible substrate and with an 18 degree conical spray pattern of flavored fluid. Thus, adjusting the spot size or the line width (for longer time duration applications) can be accomplished by positioning the spray marker 10 at the appropriate vertical distance from the surface of the edible substrate, as shown in FIG. 2. A deposition system may be configured to continuously adjust the distance between the spray marker 10 and the edible substrate to control the concentration and amount of flavored fluid applied. It is to be understood that adjusting the distance between the spray marker 10 and the edible substrate can be accomplished regardless of the structural characteristic (static or dynamic/automated arm) of the deposition system. It is also to be understood that the spray marker 10 can be mounted at an angle with respect to edible substrates.

It is also possible to adjust the quantity of flavored fluid applied onto an edible substrate by controlling the quantity of flavored fluid flowing into a compressed air stream supplied through the atomizing air receiver 35. This allows the inclusion of another parameter for controlling the quantity and concentration of flavored fluid applied. For that purpose, the trigger air receiver 30 and the atomizing air receiver 35 are generally supplied with compressed air at predetermined pressures. The spray marker 10 generally requires from about 5 to about 30 PSI atomizing air pressure, particularly from about 8 to about 19 PSI atomizing air pressure, and more particularly from about 10 to about 12 PSI atomizing air pressure. The spray marker 10 generally requires about 70-80 PSI trigger air pressure. In other embodiments, the pressure of the compressed air supplied to the spray marker 10 through the trigger air receiver 30 and the atomizing air receiver 35 may vary.

The quantity of flavored fluid that may be applied onto an edible substrate may be from about 0.25 mL to about 1.5 mL, particularly from about 0.5 mL to about 1.0 mL, and more particularly from about 0.7 mL to about 0.9 mL.

FIGS. 3-4 show examples of a first deposition system 50 and a second deposition system 60, respectively. The first deposition system 50 and the second deposition system 60 are each characterized by supplying compressed air at 5-30 PSI and 70-80 PSI to the atomizing air receiver 35 and the trigger air receiver 30 of the spray marker 10. FIGS. 3-4 each shows the container 45 for supplying flavored fluid to the spray marker 10. In the examples shown, the flavored fluid is supplied by the force of gravity to the spray marker 10. It is possible to increase the pressure of the flavored fluid by adjusting the height of the container 45 relative to the position of the spray marker 10. A higher elevation of the container 45 with respect to the spray marker 10 can cause a higher volume of flavored fluid to be sprayed. Pressurized air is supplied to the spray marker 10 by pressure reservoirs (not shown) and controlled by pressure regulators 65 and one or two electric solenoid valves 70 as shown in FIG. 3 and FIG. 4, respectively. In the case of the deposition system 50, shown in FIG. 3, the solenoid valve 70 controls pressurized air supplied to the trigger air receiver 30.

The pressure regulators 65 are configured to release pressured air when a needle 75 marks the proper air pressure. For the first deposition system 50 and the second deposition system 60, the proper air pressure is 70-80 PSI and 5-30 PSI for trigger air pressure and atomizing air pressure, respectively. After mounting the first deposition system 50 and the second deposition system 60 as shown in FIGS. 3 and 4, respectively, the next step is to couple the solenoids 70 to at least one energy source to receive electrical signals for controlling the solenoids 70. In the first deposition system 50 and the second deposition system 60, the atomizing air may flow at full pressure (5-30 PSI) before applying a trigger signal to spray flavored fluid.

In some applications, a precision deposition system is configured to apply flavored fluid in a continuous manner as to create a stripe of flavored fluid. In one embodiment, the stripe may have a width from about ⅛″ to about 2″, and in some embodiments from about ¼″ to about 1″. The length of the stripe may generally be from about ⅛″ to about 8″, depending on the size of the edible substrate used, although longer stripes may be used with longer edible substrates. One configuration can include the spray marker 10 mounted on a fixed position while flavored fluid is applied to a moving edible substrate. Another configuration can include the spray marker 10 mounted onto a moving arm. Additionally, it is important to understand that the first deposition system 50 and the second deposition system 60 are operable to perform this application. In the case of the first deposition system 50 including one solenoid 70, the length of the stripe of flavored fluid is at least in part determined by the length of time an electrical signal is applied to the solenoid 70 controlling the trigger air. It is assumed under these conditions that the atomizing air pressure remains substantially constant, or at least at the appropriate range of air pressure, throughout the deposition process.

One way to supply an electrical signal for controlling the solenoid 70 is by using a One-Shot Timer (not shown) coupled to the solenoid 70. The One-Shot Timer can provide an adjustable time duration signal to the solenoid 70 controlling the trigger air each time the spray marker 10 needs to be fired. It is usually preferred to supply a 100 millisecond signal, though the One-Shot Timer may be adjusted to generate electrical signals with a time duration between about 0.05 and about 1 seconds. In the case of the second deposition system 60 shown in FIG. 4, the solenoids 70 are generally energized with a sequence of electrical signals to provide and maintain atomizing air pressure at the appropriate pressure when the trigger air pressure is applied. A One-Shot Timer may also be used in the second deposition system 60 by wiring the two solenoids 70 to the One-Shot Timer, where the solenoids 70 are in a parallel configuration. This configuration is characterized by supplying electrical signals to the solenoids 70 of the second deposition system 60 simultaneously.

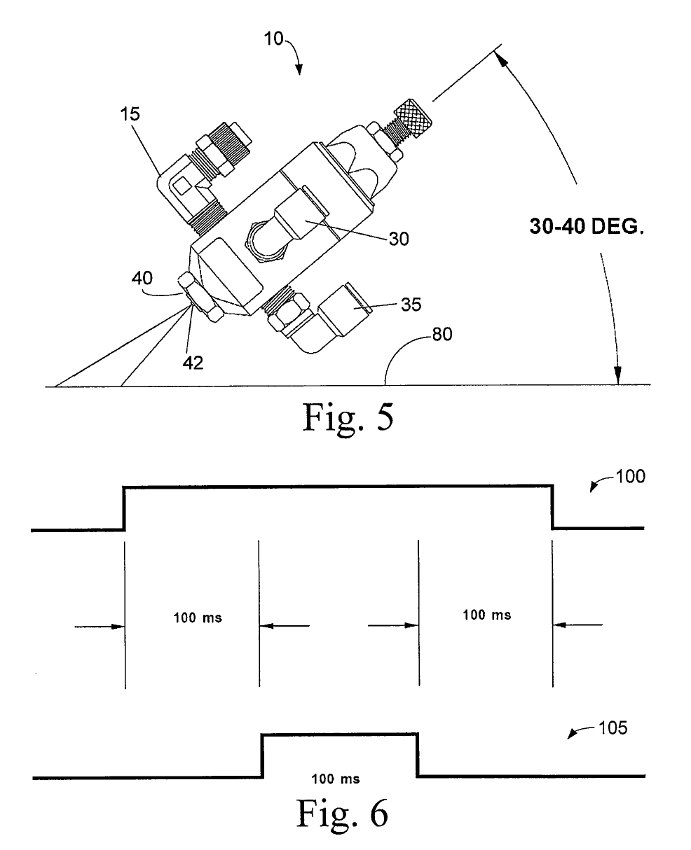

The first deposition system 50 and the second deposition system 60 shown in FIGS. 3 and 4, respectively, are only schematic representations and do not illustrate the angle at which flavored fluid is applied to edible substrates. Generally, the spray marker 10 is mounted substantially perpendicular to the edible substrate. In the applications where it is desired to apply a stripe of flavored fluid, it is normally recommended that the spray marker 10 be mounted at an angle between about 30 degrees and about 45 degrees with respect to a surface 80 supporting the edible substrate, as indicated in FIG. 5. Mounting the spray marker 10 at an angle instead of perpendicular to the surface 80, generally results in a sharper edge definition by minimizing the feathering of the spray pattern. If the spray marker 10 is mounted statically in the position shown in FIG. 5, the spray marker 10 produces an elliptical mark rather than a circular mark.

Some other applications of the first deposition system 50 and the second deposition system 60 generally include spot marking, which is characterized by the spray marker being controlled to apply a relatively small spot mark of flavored fluid to an edible substrate, which may be in motion. In this type of application, the amount of flavored fluid deposited is dependent of factors including the time duration of the electrical signal controlling the solenoids 70, adjustment of the spraying aperture 42, and the velocity at which the edible substrate is moving. For example, when applying flavored fluid in the form of spot marking to fast moving edible substrates, an approximate spray duration of 100 milliseconds may result in a short line mark and not a round spot. As a general guideline for the spray marker 10, the spot is elongated by an amount approximately equal to the distance the edible substrate travels in 1/10 of a second. For example, if the edible substrate is traveling at 12 inches per second, the spot would be elongated to a line of flavored fluid of approximately 1.2 inches in length. The spray duration may be from about 0.0001 milliseconds to about 9,999 milliseconds, preferably from about 1 millisecond to about 1000 milliseconds, and more preferably from about 100 milliseconds to about 800 milliseconds. The duration of the deposit can be determined by inputting a value in milliseconds.

The precision deposition can be controlled using at least one of the following: pressure; size of aperture opening; duration of spray; and amount of fluid.

Some of the applications for spot marking edible substrates can include the use of the second deposition system 60 shown in FIG. 4. More specifically, the second deposition system 60 may include a controller having two variable outputs to effectively control the solenoids 70 supplying pressured air to the spray marker 10. In particular, each solenoid 70 of the second deposition system 60 can be coupled to one of the variable outputs of the controller to receive electrical signals in a specific sequence. When using the controller to generate electrical signals to control the solenoids 70 of the second deposition system 60, the solenoid supplying atomizing air can be energized first to allow time for the relatively lower pressure atomizing air to flow at full volume through the receiver 35 of the spray marker 10. The amount of time for this to occur depends in part on the length of connecting tubes 85 containing atomizing air but typically 50-100 milliseconds is an adequate delay before energizing the solenoid 70 controlling trigger air. The solenoid 70 controlling trigger air is then energized for approximately 100 milliseconds. After the solenoid 70 controlling trigger air is de-energized, the atomizing air is generally allowed to continue flowing for another 50-100 milliseconds to ensure all flavored fluid residue is blown off the spraying portion 40 of the spray marker 10. A typical pulse sequence generated by the controller is shown in FIG. 6. More specifically, a signal 100 exemplifies the electrical signal supplied to the solenoid 70 controlling atomizing air, and a signal 105 exemplifies the electrical signal supplied to the solenoid 70 controlling trigger air. FIG. 6 shows approximate 100 millisecond delay signals and trigger signal, though other embodiments may include different time durations for delay signals and trigger signals based on the amount of flavored fluid to be sprayed.

In some embodiments, a shaft encoder (not shown) may be used in connection with the deposition system. The shaft encoder provides signal pulses to the equipment based on the speed at which the product is traveling. If there are variations in the speed of the moving edible substrate, the encoder provides that information to the depositing system, which adjusts accordingly. This may provide consistency in placement and volume deposited of the flavored fluid. Encoders are commercially available from Danaher Industrial Controls in Gurnee, Ill. and Encoder Products Company Inc. in Sagle, Id.

An edible substrate having any one of the above-described food grade flavored fluids applied to one or more surfaces thereof is also provided.

Food grade colored fluids for use in printing on edible substrates, methods for applying the food grade colored fluids directly to edible substrates, and edible substrates having the colored fluids applied thereto are provided. The food grade colored fluids are typically made from food grade dyes and glycols and optionally water and/or glycerine. The food grade colored fluids have characteristics that render them suitable for printing directly onto the surfaces of a variety of edible substrates. In particular, the food grade colored fluids may be suitable for printing with ink jet printers, including piezoelectric ink jet printers. As used herein, the phrase “food grade” means that up to specified amounts of the particular compound can be ingested by a human without generally causing deleterious health effects. Examples of food grade compounds include those compounds “generally recognized as safe” (“GRAS”) by the United States Food and Drug Administration (“FDA”) and colorants approved by the FDA for use in foods for human consumption. In particular, food safe compounds include those compounds listed as approved under 21 C.F.R. §§ 73, 74, 172, 182 and 184.

The colored fluids may contain substantial amounts of food grade glycols, such as 1,2-propanediol. In some embodiments, the colored fluids include at least about 10 weight percent (wt. %) food grade glycol. This includes embodiments where the colored fluids include at least about 25 wt. % food grade glycol and further includes embodiments where the colored fluids include at least about 40 wt. % food grade glycol. In addition to the food grade glycols, the colored fluids may optionally include water, glycerine or a mixture of water and glycerine. In one typical embodiment, the food grade glycol and any water or glycerine present account for at least about 90 wt. % of the food grade colored fluid.

The food grade colored fluids may be prepared with a low water content. For example, in some embodiments the food grade colored fluids may contain no more than about 35 wt. % water. This includes embodiments where the colored fluids contain no more than about 20 wt. % water, further includes embodiments where the colored fluids contain no more than about 5 wt. % water. The food grade colored fluids may be free of or substantially free of water, e.g. having a water content of no more than about 1 wt. %. In these compositions, any water present may be due solely or partially to water absorbed from the air under humid conditions and/or water introduced as an impurity or minor component of one of the dyes or solvents that make up the colored fluids. It is advantageous to limit the amount of water present in the colored fluids because a high water content tends to decrease the viscosity of the fluids, rendering them less suitable for use in some printing applications, such as ink jet printing applications where elevated jetting temperatures are used.

Although not a necessary ingredient, glycerine is a useful co-solvent because many of the food grade dyes used in the colored fluids exhibit high solubility in glycerine. Typically, when glycerine is present, it makes up at least about 3 wt. % of the colored fluid. This includes embodiments where glycerine makes up at least about 10 wt. % of the colored fluid, further includes embodiments where glycerine makes up at least about 20 wt. % of the colored fluid, and still further includes embodiments where glycerine makes up at least about 30 wt. % of the colored fluid. The amount of glycerine present, if any, will depend on a variety of factors, including the extent to which the food grade dyes are soluble in the food grade glycols. Thus, some of the colored fluids may contain a relatively small amount of glycerine (e.g. about 2 to 10 wt. %) and others may contain a larger amount of glycerine (e.g. about 30 to 45 wt. %). In still other embodiments, glycerine is present in intermediate quantities (e.g. about 12 to 18 wt. %).

In certain embodiments, the food grade dyes include food grade dye; glycerine; at least about 25 wt. % 1,2-propanediol (and commonly at least about 50 wt. % 1,2-propanediol); and a surface tension modifier. In such colored fluids the 1,2-propanediol, glycerine and any optional water commonly make up at least about 90 wt. % of the colored fluid. Any water present generally makes up no more than about 35 wt. % of the colored fluid and more suitably, no more than about 10 wt. %. The surface tension modifier may include a sorbitan ester (e.g., one or more fatty acid monoesters of a polyoxyethylene sorbitan), fatty acid(s) such as a mixture of tall oil fatty acids, a fatty acid polyol partial ester (e.g., one or more polyglycerol fatty acid monoesters such as octaglycerol monooleate) and/or lecithins (e.g. hydroxylated lecithins).

The food grade dyes used to produce the colored fluids may include synthetic dyes, natural dyes, or combinations thereof. As used herein, the term “dye” denotes dyes which are soluble in water and/or in the other cosolvents, which contain substantial amounts of glycols and/or glycerine, employed in the present colored fluids. In some embodiments, the colored fluids may be substantially free of insoluble materials. Suitable synthetic dyes for use in the present coloring fluids include food grade FD&C dyes, such as FD&C Red #3, FD&C Red #40, FD&C Yellow #5, FD&C Yellow #6, FD&C Blue #1, and FD&C Green #3. Suitable natural dyes include turmeric oleoresins, cochineal extracts, gardenia extracts, and natural colors derived from vegetable juices. Other specific examples of suitable natural dyes include, but are not limited to, beet extract, grape skin extract, and chlorophyll containing extracts (e.g. nettle extract, alfalfa extract and spinach extract). To achieve a desired color tint or shade, the colored liquids may include mixtures of more than one synthetic and/or natural food grade dye. In a typical embodiment, the colored fluids contain about 0.1 to 10 wt. % food grade dye on a dissolved solids basis (dsb). This includes embodiments where the colored fluids contain about 0.5 to 7.5 wt. % (dsb) food grade dye and further includes embodiments where the colored fluids contain about 0.5 to 5 wt. % (dsb) food grade dyes.

Because they are intended for use on edible substrates, the colored fluids are desirably made with high purity food grade dyes. For example, the food grade dyes used in the colored fluids may be at least about 85 wt. % pure. That is, the dyes may contain no more than about 15 wt. % contaminants and impurities, including moisture. In some instances, the food grade dyes are at least about 87 wt. % pure. Alternatively, the purity of the dyes may be analyzed on a strictly dry weight basis, in which case the food grade dyes are desirably at least about 92 wt. % pure. In some embodiments the food grade dyes are at least about 95 wt. % pure when analyzed on a dry weight basis. This includes embodiments where the food grade dyes are at least about 98 wt. % pure when analyzed on a dry weight basis.

Inorganic salts, such as sodium chloride and sodium sulfate, are examples of common impurities found in food grade dyes, such as food grade FD&C dyes. Unfortunately, fluids having elevated salt contents may be corrosive to printer parts and lead to shorter printer lifetimes. Therefore, it is typically advantageous to use food grade dyes having a low inorganic salt content, or at least a low chloride and/or sulfate ion content, in the preparation of the colored fluids. In some exemplary embodiments, the colored fluids contain one or more synthetic food grade dyes having an inorganic salt content, and more specifically in some instances a chloride and/or sulfate ion content, of no more than about 0.5 wt. %. This includes embodiments where the colored fluids contain one or more synthetic food grade dyes having an inorganic salt content, or at least a chloride and/or sulfate ion content, of no more than about 0.2 wt. % desirably no more than about 0.1 wt. %. The salt (e.g. chloride and or sulfate ion) impurity level in the synthetic food grade will desirably be no more than about 1000 ppm. In some embodiments, the chloride and/or sulfate level will be no more than about 500 ppm and in still other embodiments the chloride and/or sulfate level will be no more than about 100 ppm.

In addition to food grade dyes and glycols and any optional glycerine and/or water, the food grade colored fluids may contain various food grade additives, such as surface tension modifiers, thickening agents, antioxidants, preservatives, buffering agents, and antimicrobial agents. These additional additives are typically present in small quantities, for example, no more than about 10 wt. % and desirably no more than about 5 wt. %. Lower alcohols (i.e. alcohols having one to six carbon atoms), such as isopropanol, ethanol, n-butyl alcohol, and i-butyl alcohol, or mixtures thereof are examples of additives that might be present in limited amounts in the colored fluids. The lower alcohols may be used as surface tension modifiers and will generally be present in amounts of no more than about 10 wt. %. This includes embodiments where the lower alcohols are present in amounts of no more than about 5 wt. % and further includes embodiments where the lower alcohols are present in amounts of no more than about 0.5 wt. %.

The colored fluids desirably have properties that render them suitable for use as printing inks in various types of printers, including ink jet printers which utilize piezoelectric printheads. Viscosity is one property of the colored fluids that may be controlled to produce fluids suitable for ink jet printing. It is generally desirable for the colored fluids to have a viscosity of about 8 to 14 centipoise (cps) at the jetting temperature at which the printing is to take place. In some embodiments, the colored fluids have a viscosity of 8 to 14 cps at the desired jetting temperature. Typical jetting temperatures may range from room temperature, about 25° C., to elevated temperatures of at least about 80° C. or even higher. Typical elevated jetting temperatures may range from about 50 to 70° C. For example, a colored fluid may have a viscosity of about 8 to 14 cps at a jetting temperature of 60° C. Alternatively, a colored fluid may have a viscosity of about 8 to 14 cps at a jetting temperature of 25° C.

In one aspect, the invention features a system for printing on an edible substrate. The system includes a high frequency piezoelectric inkjet printer for jetting at 10 kHz or greater and a fluid for printing on an edible substrate including a surfactant, the fluid preferably having a surface tension of about 20 dynes/cm to about 40 dynes/cm. The fluid may include a surfactant that includes a polysiloxane and that has a surface tension of about 20 dynes/cm to about 40 dynes/cm. The edible substrate remains edible after being printed with the fluid.

In another aspect, the invention features a method of printing on an edible substrate. The method includes providing an inkjet printer; obtaining a pre-fluid having a surface tension of greater than about 36 dynes/cm; and adding a sufficient amount of a surfactant comprising a polysiloxane to the pre-fluid to reduce the surface tension by at least 10 percent to obtain a lower surface tension fluid suitable for applying to an edible substrate, the edible substrate remaining edible after printing; and jetting the lower surface tension fluid onto the edible substrate.

The colored fluids presented herein desirably, but not necessarily, exhibit Newtonian viscosities, that is, viscosities that do not change with shear rate. In particular, the colored fluids may exhibit a Brookfield viscosity that changes by no more than about 2 cps with a shear rate increase from about 15 to 45 rpm when measured at a temperature selected from a temperature in the range of 20 to 70° C. (e.g., 60° C.). In some embodiments, the colored fluids exhibit a Brookfield viscosity that changes by no more than about 1 cps and in still other embodiments, the colored fluids exhibit a Brookfield viscosity that changes by no more than about 0.5 cps with a shear rate increase from about 15 to 45 rpm when measured at a temperature selected from a temperature in the range of 20 to 70° C. (e.g., 60° C.).

The colored fluids will typically have surface tensions of about 20 to 60 dynes per centimeter (cm) at 25° C. This includes embodiments where the colored fluids have surface tensions of about 25 to 50 dynes per cm at 25° C. The surface tensions of the colored fluids may be lowered by using surface tension modifiers. Suitable surface tension modifiers for use in the colored fluids include, but are not limited to, sorbitan esters (e.g. polyoxyethylene sorbitan esters), fatty acids (e.g. tall oil fatty acids), mixtures of fatty acids, esters of fatty acids (e.g. polyglycerol esters of fatty acids) and lecithins. Using these surface tension modifiers, food grade colored fluids having surface tensions of no more than about 40 dynes per cm, more suitably no more than about 38 dynes per cm at 25° C. and desirably no more than about 35 dynes per cm at 25° C. may be prepared. Typically, the colored fluids will contain no more than about 10 wt. % surface tension modifier and desirably no more than about 5 wt. % surface tension modifier. For example, the colored fluid may include about 0.05 to about 3 wt. % of a sorbitan ester, e.g., a polyoxyethylene sorbitan ester such as polyoxyethylene sorbitan monopalmitate and/or polyoxyethylene sorbitan mono laurate. In other embodiments, the colored fluid may include about 1 to about 5 wt. % of a mixture of fatty acids, e.g., tall oil fatty acids, such as a mixture of oleic acid and linoleic acid. In yet other embodiments, the colored fluid may include about 0.1 to about 3 wt. % of a fatty acid monoester of a polyglycerol (e.g., octaglycerol), such as octaglycerol monooleate.

Other suitable surface tension modifiers for use in the present colored fluids include lecithins and, in particular, lecithins that have been deoiled and modified to enhance their water solubility (i.e., lecithins having an enhanced HLB value). Examples of suitable lecithins include hydroxylated lecithin (e.g., hydroxylated soy lecithin), enzyme modified lecithin (e.g., enzyme modified soy lecithin) and acetylated, hydroxylated lecithin. Embodiments of the colored fluid may include about 0.1 to about 3 wt. % of a modified lecithin, such as a lecithin having an HLB value of at least about 9, e.g., about 0.3 to about 2 wt. % hydroxylated soy lecithin.

Other suitable surface tension modifiers for use in the present colored fluids include polysiloxanes. Examples of suitable polysiloxanes include ether-modified or polyether-modified polydimethylsiloxanes, hydroxy-functional polydimethylsiloxanes, ester-modified or a polyester-modified polydimethylsiloxanes, polydimethylsiloxane, octamethylcyclotetrasiloxane, phenyl siloxanes, dimethicones, and silsesquioxanes, such as fully or partially condensed silsequioxanes, silicone waxes, and alkylmethylsiloxanes.

Polysiloxanes are available from, for example, Noveon, under the tradename UTRASIL™, Dow Corning®, Struktol Company of America. In particular, ether-modified polydimethylsiloxanes, such as BYK-333, are available from BYK Chemie. Silsesquioxanes are available, for example, from Aldrich Chemical and Reade Advanced Materials. Preparation of Silsesquioxanes and their Reaction Chemistry is Generally Discussed in “Silsesquioxanes, Bridging the Gap Between Polymers and Ceramics”, Chemfiles, Vol. 1, No. 6, 2001 (Aldrich Chemical), the entire contents of which is hereby incorporated by reference herein.

To prevent clogging of ink jet printer nozzles it is advantageous to provide colored fluids having reduced particle content. Particle content may be characterized by the silt density index (SDI) of the fluid. SDI values provide a measure of particle content that relates the rate of membrane clogging to the quantity of particulate matter present in a fluid. SDI values may be measured as follows: two aliquots of equal volume of the fluid to be tested are poured sequentially into a filter and the time required for each aliquot to pass through the filter is measured. The SDI is provided by the ratio of the time it takes the first aliquot to pass through the filter to the time it takes the second aliquot to pass through the filter. A higher SDI value indicates a fluid having a lower particle content. A fluid that has no buildup on the filter, and therefore very little particle content, will have an SDI value of 1. The food grade colored fluids provided herein include, but are not limited to, fluids having an SDI of at least about 0.5. In certain embodiments the colored fluids have an SDI of at least about 0.75. This includes embodiments where the colored fluids have an SDI of at least about 0.9.

Unless otherwise noted, an SDI value for a given liquid sample may be measured at any arbitrary time after the sample is prepared without requiring any particular set of processing conditions to have been preformed prior to the measurement. In some cases, see Example 1 below, a Heat Test SDI value is quoted. As used herein, a Heat Test SDI value is measured after heat-aging the sample for at least 11 days at a temperature of at least 70° C. according to the procedure described in Example 1.

The food grade colored fluids may also have a relatively low specific gravity. In a typical embodiment, the food grade colored fluids may have a specific gravity of no more than 1.15. This includes embodiments where the colored fluids have a specific gravity of no more than 1.13 and further includes embodiments where the colored fluids have a specific gravity of no more than 1.10.

Once prepared, the present colored fluids may be printed directly onto the surfaces of a variety of edible substrates using conventional printing equipment, such as ink jet printers. The surfaces onto which the fluids are printed are desirably porous in order to facilitate absorption of the dye by the surface. Suitable edible substrates include, but are not limited to, crackers, chewing gum, biscuits, cereal, taco shells, granola bars, rice cakes, cookies, pie crusts, waffles, cakes, including snack cakes, marshmallows, candies, pasta and various bread products, such as toast, buns, bagels and tortillas.

In one embodiment, the invention provides a system for printing on an edible substrate, comprising: a piezoelectric inkjet printer configured to jet at 10 kHz or greater; and a fluid for printing on an edible substrate comprising a surfactant comprising a polysiloxane and having a surface tension of about 20 dynes/cm to about 40 dynes/cm, wherein the edible substrate remains edible after being printed with the fluid.

The surface tension of some embodiments of the colored fluid may be from about 26 dynes/cm to about 36 dynes/cm, from about 28 dynes/cm to about 32 dynes/cm. The viscosity of some embodiments of the colored fluid may be about 5 to about 25 cps, or about 10 to about 14 cps. The concentration of the surfactant of the colored fluid may be about 2 g/L to about 40 g/L.

In one embodiment, the invention provides a method of printing on an edible substrate, the method comprising: providing an inkjet printer, obtaining a pre-fluid having a surface tension of greater than about 36 dynes/cm; and adding a sufficient amount of a surfactant comprising a polysiloxane to the pre-fluid to reduce the surface tension by at least 10 percent to obtain a lower surface tension fluid suitable for applying to an edible substrate, the edible substrate remaining edible after printing, and jetting the lower surface tension fluid onto the edible substrate. The surface tension of the colored fluid may be reduced by at least about 25 percent.

Food grade colored fluids are provided. Food grade colored fluids are described in United States Patent Application Publication Number 20060034984, the subject matter of which is hereby incorporated by reference in its entirety. The food grade colored fluids, which contain at least one food grade dye and a food grade glycol, such as 1,2-propanediol, are useful for printing directly onto the surfaces of various edible substrates. As used herein, “food grade” means that up to specified amounts of the particular compounds can be ingested by a human without generally causing deleterious health effects. Therefore, in order to meet the standard of a “food grade” colored fluid, the colored fluid should be free or substantially free of compounds that generally cause deleterious health effects when ingested by a human. When such compounds are present, e.g. in trace amounts through contamination, those compounds should be present in amounts below those that would result in the deleterious health effects.

The food grade colored fluids are well-suited for use with a variety of ink jet piezo printheads. Examples of manufacturers from which the printheads may be obtained include Spectra, Xaar, Hitachi and PicoJet. The printhead may include a nozzle opening of metal, carbon or silicon. The nozzle opening may be of about 50 μm or less. The printhead may have a resolution of about 100 dpi or greater, and may operate at a jetting temperature of about 50° C.

Edible substrates onto which the colored fluids have been applied are also provided. Examples of edible substrates onto which the food grade colored fluids may be printed include, but are not limited to, crackers, chewing gum, biscuits, cereal, taco shells, granola bars, rice cakes, cookies, pie crusts, waffles, cakes, including snack cakes, marshmallows, candies, pasta, and various bread products such as toast, buns, bagels, and tortillas. This surface of the edible substrate onto which the food grade colored fluids are applied is desirably a porous surface which facilitates the absorption of the food grade colored fluids by the surface, hastening drying. As used herein, the term “porous surface” is intended to include any surface having sufficient porosity to allow the food grade colored fluids to be at least partially absorbed. The food grade colored fluids may also be applied to nonporous edible surfaces, however, the application of the colored fluids to such surfaces may require a drying step after the colored fluid has been applied.

The food grade glycol acts as a solvent and may account for a large part of the colored fluid. For example, the food grade glycol may account for at least about 25 wt. % of the colored fluid. This includes embodiments where the food grade glycol accounts for at least about 40 wt. % of the colored fluid, further includes embodiments where the food grade glycol accounts for at least about 70 wt. % of the colored fluid, and still further includes embodiments where the food grade glycol accounts for at least about 85 wt. % of the colored fluid. Optionally, glycerine, water, or a mixture of glycerine and water, may be used as co-solvents along with the food grade glycol. However, in many colored fluids the amount of water present in the colored fluids may be limited in order to maintain a higher viscosity. For some applications, higher viscosities may be advantageous because they can render the colored fluids suitable for ink jet printing at elevated jetting temperatures.

Glycerine is a good co-solvent of choice because of its relatively low volatility and its presence may assist in solubilizing some of the food grade dyes. As such, glycerine helps prevent the food grade dyes from solidifying out of solution, crusting onto and clogging jetting nozzles. When glycerine is used as a co-solvent, it is typically present in an amount of at least about 3 wt. %. This includes embodiments where glycerine is present in an amount of at least 10 wt. %, further includes embodiments where glycerine is present in an amount at least about 20 wt. %, still further includes embodiments where the glycerine is present in an amount of at least 30 wt. %, and even further includes embodiments where the glycerine is present in an amount of at least about 45 wt. %. In one exemplary embodiment, the food grade colored fluids contain at least about 70 wt. % 1,2-propanediol, glycerine or a mixture thereof. In another exemplary embodiment, the food grade colored fluids contain about 25 to 95 wt. % 1,2-propanediol, about 3 to 40 wt. % glycerine and no more than about 35 wt. % water.

The food grade dyes used to produce the colored fluids may be synthetic dyes, natural dyes or a mixture of synthetic and natural dyes. The food grade dyes may include any dyes which are soluble in at least one of 1,2-propanediol, glycerine, water, or mixtures thereof. In some embodiments, it is desirable that the food grade colored fluids be free of insoluble coloring agents such as a pigments or lakes. Examples of suitable dyes include, but are not limited to, synthetic dyes, such as FD&C dyes (e.g., FD&C Red #3, FD&C Red #40, FD&C Yellow #5, FD&C Yellow #6, FD&C Blue #1, and/or FD&C Green #3).

Examples of suitable natural dyes include, but are not limited to, turmeric oleoresins, cochineal extracts including carminic acid, gardenia extracts, beet extracts, and other natural colors derived from vegetable juices, and chlorophyll-containing extracts, such as nettle extract, alfalfa extract and spinach extract. Anthocyanins are another class of food grade dyes that may be used in the colored fluids. The anthocyanins may be derived from a variety of plant sources, including fruit juices, elderberries, black currants, chokeberries, vegetable juices, black carrots, red cabbage, grapes and grape skins, and sweet potatoes. Although the relative amount of the food grade dyes used in the food grade colored fluids may vary depending on the desired color, shade and intensity, the food grade colored fluids will typically contain about 0.1 to 10 wt. % (dsb) food grade dye. This includes embodiments where the colored fluids contain about 0.5 to 7.5 wt. % (dsb), and further includes embodiments where the colored fluids contain about 0.5 to 5 wt. % (dsb) food grade dye.

The food grade dyes used to produce the colored fluids are desirably high purity food grade dyes. In some instances, the food grade dyes may possess purities of at least 85 wt. %, where any water present in the dye is included as an impurity. This includes embodiments where the food grade dyes are at least 87 wt. % pure. When the purity of the dye is analyzed strictly on a dry weight basis, the food grade dyes desirably have a purity of at least 92 wt. %. This includes embodiments where the food grade dyes have a purity of at least about 95 wt. % and still further includes embodiments where the food grade dyes have a purity of at least about 98 wt. % when analyzed on a dry weight basis. Typical impurities found in commercially available food grade dyes, including many FD&C dyes, may include minerals, such as calcium, metals, such as iron, salts such as sodium chloride and sodium sulfate, and small amounts of water. Typically, the impurity level of minerals and metals in the food grade dyes will be no more than about 50 ppm. However, in some instances, the impurity levels of these components will be much less. For example, in some of the food grade dyes, the impurity level of calcium will be no more than about 10 ppm and desirably no more than about 5 ppm. Similarly, in many suitable food grade dyes, the impurity level of iron will be no more than about 10 ppm and desirably no more than about 4 ppm. Water will typically be present as an impurity in the food grade dyes in an amount of no more than about 5 wt. %. This includes embodiments where water is present as an impurity in an amount of no more than about 2 wt. % and still further includes embodiments where water is present as an impurity in the food grade dyes in an amount of no more than about 1 wt. %.

Some inorganic salts are particularly undesirable impurities because these salts tend to corrode printer parts, including printing heads which reduces the lifetime of the printers used to apply the dyes. Therefore, for certain applications it may be advantageous to reduce the level of inorganic salt impurities in the food grade dyes. When a mixture of food grade dyes is utilized, a reduction in inorganic salt content and corrosiveness may be achieved provided at least one of the food grade dyes, and in particular at least one FD&C food grade dye, has a low inorganic salt content (as a percentage of total solids content in the dye). It such embodiments, it may be desirable for any food grade dyes that do not have a low salt content to be present in amounts of no more than about 1 wt. % or in amounts of no more than about 0.6 wt. %. In some colored fluids containing a mixture of food grade dyes, all of the food grade dyes in the mixture have a low inorganic salt content. In some embodiments the food grade colored fluids provided herein are made with one or more synthetic food grade dyes having an inorganic salt impurity level of no more than about 0.5 wt. %. This includes embodiments where one or more of the synthetic food grade dyes has an inorganic salt content of no more than about 0.2 wt. % and further includes embodiments where one or more of the synthetic food grade dyes has an inorganic salt content of no more than about 0.1 wt. %. Alternatively stated, in some instances, the inorganic salt impurity level in one or more of the synthetic dyes will be no more than about 1,000 ppm. In other instances, the inorganic salt impurity level in one or more of the synthetic food grade dyes will be no more than about 500 ppm and in still other instances the inorganic salt impurity level in one or more of the synthetic dyes will be no more than about 100 ppm. Two typical corrosive inorganic salts found in commercially available dyes, including synthetic dyes, such as FD&C food grade dyes are chlorides, which usually take the form of sodium chloride, and sulfates, which typically take the form of sodium sulfates. In some instances it may be possible for the colored fluids to include higher levels of certain less corrosive salts provided the levels of chlorides and/or sulfates in the dyes remains low. The impurity limits cited above with respect to chloride and sulfate levels refer specifically to the amount of chloride and/or sulfate ion content in the colored fluids. Table A below shows exemplary formulations for two high-purity, low-salt food grade dyes that may be used to produce the food grade colored fluids. Both dyes shown in Table A are available from Sensient Colors Inc., St. Louis, Mo.

TABLE A
Low Inorganic Salt Food Grade Dyes

| | Low Salt FD&C Yellow | | Low Salt FD&C Blue 1 | |
|---|---|---|---|---|
| Calcium | 5 | ppm | — | |
| Iron | 4 | ppm | — | |
| Water | — | | 3.6 | wt. % |
| NaCI | 25 | ppm | 2 | ppm |
| Na₂SO₄ | 51 | ppm | 34 | ppm |
| Dye | 95 | wt. % | 95 | wt. % |

In addition to the food grade dyes and glycols and any optional glycerine and/or water co-solvents, the food grade colored fluids may contain other food grade additives such as surface tension modifiers, thickening agents, antioxidants, preservatives, buffering agents, and anti-microbial agents. These additional additives will typically be present only in small quantities. For example, the additional food grade additives may be present in amounts of no more than about 10 wt. %. This includes embodiments where the food grade additives are present in amounts of no more than about 5 wt. % and further includes embodiments where the food grade additives are present in amounts of no more than about 3 wt. %. The additives may include isopropanol, ethanol, or mixtures thereof as surface tension modifying agents. In a typical embodiment, a colored fluid may contain no more than about 10 wt. % isopropanol, ethanol, or a mixture thereof and more typically about 1 to 5 wt. %. The colored fluids may contain no more than about 3 wt. % lower alcohol and in some embodiments the colored fluids may be substantially free of lower alcohol, such as isopropanol, i.e., contain no more than about 0.5 wt. % lower alcohol. Methylparaben, propylparaben or mixtures thereof may be included in the food grade colored fluids as preservatives. For some applications it is desirable to exclude certain additives. For example, some food grade colored liquids in accordance with this disclosure may be free of or substantially free of one or more of the following additives: glycol ethers, polyol monoethers, urea, tetraalkylammonium cations (e.g. tetramethylammonium cations), alkanol ammonium compounds (e.g., monoethanol ammonium compounds, diethylammonium compounds, or triethanol ammonium cations), cationic amide compounds (e.g., protonated formamide), silica, sebacyl chlorides, binding agents and film-forming agents. A food grade colored fluid is “substantially free of” an additional food grade additive if the colored fluid contains no more than about 0.5 wt. % of the additional food grade additive. In some instances, the food grade colored fluid contains no more than about 0.2 wt. % of a given additive. In still other instances the food grade colored fluid contains no more than about 0.1 wt. % of a given additive. For example, it may be desirable to have food grade colored fluids which contain no more than about 0.05 wt. % binding agents and/or film-forming agents, such as polymers, gum arabic, hydrocolloids, xanthum gum, waxes, alginates and polysaccharides.

For ink jet printing applications, it is generally desirable for the colored fluids to have a viscosity of about 8 to 14 centipoise (cps) at the jetting temperature at which the printing is to take place. This includes embodiments where the colored fluids have a viscosity of 8 to 12 cps at the desired jetting temperature. Some ink jet printers are designed to be operated at ambient temperatures (i.e. about 25° C.). Other ink jet printers are designed for operation at elevated print head temperatures. For example, an ink jet printer may operate at jetting temperatures ranging from about 50 to 70° C. Therefore, the formulation of the colored fluids, including the ratio of food grade glycol to glycerine and the amount of water present, is desirably controlled to provide a suitable viscosity for the intended jetting temperature. For example, a colored fluid may be tailored to have a viscosity of about 8 to 14 cps at a jetting temperature of 60° C. However, the viscosity of these colored fluids may be significantly higher at ambient temperatures. For example, the colored fluids may have viscosities of about 35 to 65 cps at 25° C. Alternatively, a colored fluid may be tailored to have a viscosity of about 8 to 14 cps at a jetting temperature of 25° C.

It has been discovered that colored fluids exhibiting Newtonian viscosities, perform favorably as printing inks for edible substrates. Thus, in some embodiments, the colored fluids have Newtonian viscosities. Specifically, the colored fluids may exhibit a Brookfield viscosity that changes by no more than about 2 cps with a shear rate increase from about 15 to 45 rpm at 60° C. In some embodiments, the colored fluids exhibit a Brookfield viscosity that changes by no more than about 1 cps and in still other embodiments, the colored fluids exhibit a Brookfield viscosity that changes by no more than about 0.5 cps with a shear rate increase from 15 to 45 at 60° C.

The surface tension of the colored fluids may vary over a relatively wide range, provided it is suitable to allow the colored fluids to be jetted through an ink jet printing head and printed onto the surface of an edible substrate. In some embodiments, the colored fluids will have surface tensions of about 20 to 60 dynes per cm at 25° C. This includes embodiments where the colored fluids have surface tensions of 35 to 50 dynes per cm at 25° C.

Embodiments may include one or more of the following. The surface tension is from about 26 dynes/cm to about 36 dynes/cm, e.g., about 28 dynes/cm to about 32 dynes/cm. The fluid has a viscosity of about 5 to 25 cps, e.g. about 10 to 14 cps. The fluid is substantially aqueous. The surfactant is an ether-modified polydimethylsiloxane, a polydimethylsiloxane, a lecithin, a lecithin derivative, a phospholipid, a glycerol ester, an amphoteric amino acid, an amphoteric imino acid, a sorbitol, sorbitan, a glycol ester, a glycerol ester, an ester-modified polydimethylsiloxane, or mixtures of these. The concentration of the surfactant in the fluid is from about 2 g/L to about 40 g/L.

In some instances, surface tension modifiers may be included in the colored fluids to lower their surface tensions. Sorbitan esters are an example of a type of surface tension modifier that may be used in the colored fluids. Suitable sorbitan esters include polyoxyethylene sorbitan esters. Food grade polyoxyethylene sorbitan esters are commercially available under the tradename Tween®. These include Tween® 80 (polyoxyethylene sorbitan monooleate); Tween® 65 (polyoxyethylene sorbitan tristearate); Tween® 60 (polyoxyethylene sorbitan monostearate); Tween® 40 (polyoxyethylene sorbitan monopalmitate); and Tween® 20 (polyoxyethylene sorbitan monolaurate). Fatty acids, such as tall oil fatty acids, and mixtures of fatty acids may also be employed as surface tension modifiers in the food grade colored fluids. Acintol (also known as Sylfat® FA-1), a fatty acid mixture available from Arizona Chemical (Panama City, Fla.) is an example of a suitable surface tension modifier. Acintol is a mixture of about 40-45 wt. % oleic acid and 40-45 wt. % linoleic acid (conjugated and nonconjugated). Esters of fatty acids, such as polyglycerol esters of fatty acids, are another group of surface tension modifiers that may be added to the colored fluids. Santone® 8-1-0, octaglycerol monooleate (available from Loders Croklaan, Netherlands) is one example of a food grade polyglycerol ester suitable for use as a surface tension modifier.

Other suitable surface tension modifiers for use in the present colored fluids include lecithins and, in particular, lecithins that have been deoiled and modified to enhance their water solubility (i.e., lecithins having a relatively high HLB value). Examples of suitable lecithins include hydroxylated lecithin (e.g., hydroxylated soy lecithin), enzyme modified lecithin (e.g., enzyme modified soy lecithin) and acetylated, hydroxylated lecithin. Embodiments of the colored fluid may include about 0.1 to about 3 wt. % of a modified lecithin, such as a lecithin having an HLB value of at least about 9, e.g., about 0.3 to about 2 wt. % hydroxylated soy lecithin. One example of a commercially available lecithin material that may be used in the colored fluids provided herein is sold under the tradename Yelkin® 1018 (ADM, Decatur, Ill.).

Lecithin material may be obtained in many forms and a variety of common natural forms of lecithin material have been observed. In commercial practice, products such as soy lecithin material include primarily 3 or 4 of the possible forms and are commonly sold as unfractionated mixtures. Lecithin material from different sources may be made up of different mixtures. The properties of these mixtures can be modified by chemical and/or enzymatic treatments to alter the hydrophilic-hydrophobic balance as desired for the final intended use. One example of such a modification is oxidation with oxygen, which ultimately results in a lecithin that contains hydroxyl groups on the lipid side chains of the diglyceride moiety. This decreases the hydrophobicity of the lecithin and increases the overall polarity of the molecule.

Other suitable surface tension modifiers for use in the present colored fluids include molecules containing silicon, such as siloxanes and polysiloxanes. Examples of suitable polysiloxanes include ether-modified or polyether-modified polydimethylsiloxanes, hydroxy-functional polydimethylsiloxanes, ester-modified or a polyester-modified polydimethylsiloxanes, polydimethylsiloxane, octamethylcyclotetrasiloxane, phenyl siloxanes, dimethicones, and silsesquioxanes, such as fully or partially condensed silsequioxanes, silicone waxes, and alkylmethylsiloxanes.

Polysiloxanes are commercially available from Noveon, under the tradename UTRASIL™, Dow Corning® and Struktol Company of America. In particular, ether-modified polydimethylsiloxanes are commercially available from BYK Chemie, e.g., BYK®-333. Silsesquioxanes are commercially available from Aldrich Chemical or from Reade Advanced Materials. Preparation of silsesquioxanes and their reaction chemistry is generally discussed in “Silsesquioxanes, Bridging the Gap Between Polymers and Ceramics”, Chemfiles, Vol. 1, No. 6, 2001 (Aldrich Chemical), the entire contents of which is hereby incorporated by reference herein.

Examples of suitable polysiloxanes include those commercially available from BYK Chemie, Wesel, Germany, such as BYK®-020 for Inks (a solution of a modified polysiloxane-copolymer in butylglycol/ethylhexanol/white spirits at a 6/2/1 ratio), BYK®-024 for Inks (a mixture of polymers and polysiloxanes), BYK®-346 for Inks, BYK®-067 A for Inks (a non-aqueous emulsion of a polysiloxane in propyleneglycol), BYK®-080A for Inks (a non-aqueous emulsion of a polysiloxane copolymer in propyleneglycol), BYK®-085 (methylalkylpolysiloxane; solvent free), BYK®-300 (a solution of a polyether modified dimethylpolysiloxane-copolymer in 2-butoxyethanol), BYK®-301 (a solution of a polyether modified dimethylpolysiloxane-copolymer in 2-butoxyethanol), BYK®-308 (a polyether modified hydroxyfunctional polydimethyl silicone), BYK®-310 for Inks (a solution of a polyester modified dimethylpolysiloxane in xylene), BYK®-323 (polymethylalkyl methylaralkyl siloxane), BYK®-333 for Inks (a polyether modified polydimethylsiloxane), BYK®-346 (a solution of a polyethermodified dimethylpolysiloxane in dipropyleneglycol monomethylether), and BYK®-1660 (an emulsion of siloxylated polyethers).

Other suitable hose commercially available from Emerald Performance Materials, LLC, Cleveland, Ohio, such as Foam Blast® 10 (several 100% active silicone antifoam compounds), Masil SF 350 FG (polydimethylsiloxanes), Masil SF 19 (silicone graft-polyether); those commercially available from GE Silicones, Waterford N.Y., such as SF18-350 (containing dimethylpolysiloxanes); and those commercially available from Cognis, Cincinnati, Ohio, such as Dehydran 1620 and Dehydran 2620 (alcohol and polysiloxane adduct mixtures).

Surfactants, which can act as surface tension modifiers, may be characterized with reference to their hydrophobic-lipophilic balance (HLB) number. The HLB number correlates roughly with the solubility of the surfactant in water, with more water soluble materials typically having a higher HLB value. Suitable lecithins for use in the present ink jet inks typically include no more than about 5 wt. % oil and have an HLB number of at least about 9, or, more desirably, at least about 10.

In one embodiment, the lecithin material used in the present colored fluid formulations may often be characterized as having high polarity, high water-solubility and relatively high HLB (e.g., an HLB of at least about 7 and more suitably, an HLB of at least about 9). Examples of such materials include hydroxylated lecithin material, acetylated lecithin material, and the like. Table B below shows HLB values for a number of commercial lecithin materials. Lecithin material having these characteristics can be made by a process which includes one or more of the known methods of modifying lecithin materials (e.g., physical, chemical, enzymatic, irradiation, etc.). Physical modification refers to blending or co-extruding lecithin materials of different characteristics to provide the desired resulting characteristics. Exposure to high-energy ionizing radiation such as cobalt-60 gamma rays, X-rays and electron beams or to UV radiation in the presence of photosensitizers and oxygen or other atmospheres, may also be used to produce modified lecithin materials characterized by higher polarity and/or higher water-solubility. For example, the lecithin material may be hydroxylated soy lecithin material.

TABLE B
HLB Value of Selected Commercial Lecithins

| Lecithin Material | HLB Value |
|---|---|
| Unmodified lecithin | 4-6 |
| Acetylated lecithin | 7-8 |
| Enzyme modified lecithin | 8-9 |
| Hydroxylated lecithin | 10-12 |

Using these surface tension modifiers, food grade colored fluids having surface tensions of less than about 40 dynes per cm at 25° C. may be prepared. This includes embodiments where the colored fluids have a surface tension of no more than about 38 dynes per cm at 25° C., further includes embodiments where the colored fluids have a surface tension of no more than about 35 dynes per cm at 25° C. and still further includes embodiments where the colored fluids have a surface tension of no more than about 32 dynes per cm at 25° C.

The surface tension modifiers are desirably added in small quantities to the food grade colored fluids. For example, in some of the food grade colored fluids provided herein, surface tension modifiers make up no more than about 10 wt. % of the colored fluid. This includes embodiments where surface tension modifiers make up no more than about 5 wt. % of the colored fluid, further includes embodiments where surface tension modifiers make up no more than about 2 wt. % of the colored fluid and still further includes embodiments where surface tension modifiers make up no more than about 1 wt. % of the colored fluid. For example, some of the food grade colored fluids provided herein will contain about 0.05 to 5 wt. % surface tension modifier.

In some instances, food grade colored fluids containing surface tension modifiers will contain no more than about 10 wt. % water and desirably no more than about 5 wt. % water.

The food grade colored liquids desirably have relatively low particle contents. As such, some of the colored liquids are solutions of one or more food grade dyes that filterable through a 0.2 μm filter. One measure of the level of particle content may be provided by the silt density index of the colored fluids, which is desirably close to 1. The food grade colored fluids provided herein include, but are not limited to, fluids having an SDI of at least about 0.5. In certain embodiments the colored fluids have an SDI of at least about 0.75. This includes embodiments where the colored fluids have an SDI of at least about 0.9 and still further includes embodiments where the colored fluids have and SDI of at least about 0.95.

Low specific gravity may be advantageous in some applications. In a typical embodiment, the food grade colored fluids may have a specific gravity of no more than 1.13. This includes embodiments where the colored fluids have a specific gravity of no more than 1.10 (e.g., about 1.00 to 1.10).

The pH values of the food grade colored fluids is not critical, however it may be advantageous to provide colored fluids with an apparent pH of at least 4 and desirably at least 5 to prevent the colored fluids from corroding printer parts. Generally, the colored fluids include, but are not limited to, those having an apparent pH in the range of about 4 to 9. This includes colored fluids having an apparent pH in the range of about 5 to 8. Apparent pH values may be read directly from any suitable, commercially available pH meter. Although these apparent pH values may not be interpreted as an index of hydrogen ion potential nor used in equilibrium computations, they are reproducible and useful for qualitative purposes.

The following illustrative embodiments are intended to further exemplify the food grade colored fluids. These embodiments should not be interpreted as limiting the scope of the colored fluids disclosed herein.

A food grade colored fluid containing a food grade dye, about 25 wt. % of a food grade glycol, which may be 1,2-propanediol, optionally glycerine and optionally water is provided. In this colored fluid, the food grade glycol and any optional glycerine and water make up at least about 90 wt. % of the colored fluid, and any water present makes up no more than about 35 wt. % of the colored fluid.

The above-described colored fluid may be further defined by a variety of additional ingredients, properties and range limitations to provide a number of different embodiments of the food grade colored fluids. A few of these embodiments will now be described in more detail. In one embodiment of the above-described colored fluid, the food grade glycol makes up at least about 40 wt. % of the colored fluid. When glycerine is present, the colored fluid may contain at least about 3 wt. % glycerine. In applications where it is desirable to limit the amount of water present, water may make up no more than about 20 wt. % of the colored fluid. In other formulations, the water may account for an even smaller fraction of the colored fluid. For example, any water present may make up no more than about 1 wt. % of the colored fluid. A specific embodiment of the above-described colored fluid may contain about 0.5 to 7.5 wt. % of the food grade dye. The food grade dye in the colored fluid may be FD&C Red #3, FD&C Red #40, FD&C Yellow #5, FD&C Yellow #6, FD&C Blue #1 or a mixture thereof. The colored fluid may include one or more synthetic food grade dyes having an inorganic salt content of no more than about 0.5 wt. %. The colored fluid may also contain a food grade natural dye instead of or in combination with one or more synthetic dyes. The colored fluid may have one or more the following properties: a viscosity of about 8 to 14 cps at 60° C., a surface tension of about 20 to 60 dynes per cm at 25° C., a specific gravity of no more than about 1.13, a silt density index of at least about 0.5, and a Brookfield viscosity at 60° C. that changes by no more than 2 cps over a shear rate range from about 10 to 45 rpm.

A food grade colored fluid containing about 0.1 to 10 wt. % food grade dye, about 25 to 95 wt. % 1,2-propanediol, about 1 to 50 wt. % glycerine, and no more than about 35 wt. % water is provided. This colored fluid has a viscosity of about 8 to 14 cps at 60° C.

A food grade colored fluid containing a food grade dye, a food grade glycol, optionally glycerine and optionally water is provided. In this colored fluid the food grade glycol and any optional glycerine and water make up at least about 90 wt. % of the colored fluid and any water present makes up no more than about 35 wt. % of the colored fluid. The colored fluid is characterized by a Brookfield viscosity at 60° C. that changes by no more than 2 cps over a shear rate range from about 10 to 45 rpm. In one embodiment, the colored fluid contains at least about 25 wt. % 1,2-propanediol as the food grade glycol. The colored fluid may have a surface tension of about 35 to 50 dynes per cm at 25° C. and/or a viscosity of about 35 to 65 cps at 25° C.

A food grade colored fluid comprising a food grade dye and at least about 25 wt. % 1,2-propanediol is provided. The food grade dye in the colored fluid has an inorganic salt content of no more than about 0.5 wt. %. The food grade colored fluid may optionally include glycerine. In some embodiments, the colored fluid contains at least about 70 wt. % 1,2-propanediol, glycerine or a mixture thereof. The colored fluid may have a viscosity of about 35 to 65 cps at 25° C.

A food grade colored fluid comprising a food grade dye and at least about 70 wt. % 1,2-propanediol, glycerine or a mixture thereof is provided. This colored fluid has a viscosity of about 35 to 65 cps at 25° C. The amount of 1,2-propanediol in the colored fluid may be substantial. For example, the colored fluid may contain at least about 40 wt. % 1,2-propanediol. This includes embodiments where the colored fluid contains at least about 85 wt. % 1,2-propanediol. Glycerine may be present in the colored fluid in amounts of about 2 to 10 wt. %. Alternatively, glycerine may be present in amounts of about 35 to 45 wt. %. The colored fluid may further include isopropanol, ethanol or a mixture thereof. Methylparaben, propylparaben or a mixture thereof may also be present in the colored fluid. In applications where a low water content is desirable, the colored fluid may contain no more than about 20 wt. % water. This includes embodiments where the colored fluid contains no more than about 1 wt. % water. The colored fluid may contain one or more of the following synthetic food grade dyes, FD&C Red #3, FD&C Red #40, FD&C Yellow #5, FD&C Yellow #6, or FD&C Blue #1. In embodiments where the colored fluid contains one or more synthetic food grade dyes, one or more of those dyes may have an inorganic salt content of no more than about 0.5 wt. %. This includes embodiments wherein at least one synthetic food grade dye has a chloride content (as sodium chloride) of no more than about 1000 ppm and a sulfate content (as sodium sulfate) of no more than about 1000 ppm. The colored fluid may also contain a natural food grade dye. The natural dye may include one or more the following dyes: a turmeric oleoresin, a cochineal extract, gardenia yellow, gardenia blue, or beet powder. The colored fluid may have one or more of the following properties: a viscosity of about 8 to 14 cps at 60° C., a surface tension of about 35 to 50 dynes per cm at 25° C., a silt density index of at least about 0.5, a specific gravity of no more than about 1.13, or a specific gravity of no more than about 1.10.

A method of applying an edible colorant to a surface of an edible substrate, by ink jet printing any one of the above-described food grade colored fluids directly onto the surface of the edible substrate is provided. The ink jet printing may take place at a range of jetting temperatures. For example, the ink jet printing may take place at a jetting temperature of about 25 to 75° C. This includes methods of printing where the ink jet printing takes place at a jetting temperature of about 50 to about 70° C. One or more piezoelectric print heads may be used in the printing process.

The inkjet printhead may include a pumping chamber, the pumping chamber formed, at least in part, of metal, carbon, or silicon. The printhead may include a nozzle opening. The nozzle opening is defined in metal, carbon or silicon. The printhead may have a nozzle opening of about 50 μm or less. The printhead may have a resolution of 100 dpi or greater. The printhead operates at a jetting temperature of about 50° C. or more. The system may include a deaeration lung. A particular inkjet printhead is the Spectra Nova-AAA jetting printing module having 256 independently addressable jets that is capable of operation of up to 600 dpi is available from Spectra, Inc., Hanover, N.H.

Piezoelectric inkjet print assemblies are described in U.S. Pat. Nos. 5,265,315, 4,825,227, 4,937,598, 5,659,346 and 5,757,391; and in published U.S. Patent Application No. 2004/0004649, the entire contents of each is hereby incorporated by reference herein.

An edible substrate having any one of the above-described food grade colored fluids applied to one or more surfaces thereof is also provided.

### EXAMPLES

Exemplary embodiments of the present food grade flavored fluids are provided in the following examples. The following examples are presented to illustrate the present food grade flavored fluids and methods for applying the flavored fluids to edible substrates and to assist one of ordinary skill in making and using the same. The examples are not intended in any way to otherwise limit the scope of the invention.

Instrumentation and Measurements

Example 1 below provides examples of various food grade flavored fluids. The ingredients (in weight percent) and several physical characteristics of the fluids are provided in Tables 1-5. The physical characteristics presented in the tables were measured as follows. Viscosity measurements were obtained using a Brookfield Programmable LVDV II⁺ Digital Calculating Viscometer and a Brookfield DV III Rheometer Model V3.3LV with ULA spindle manufactured by Brookfield Engineering Laboratories, Inc., Middleboro, Mass. Surface tension measurements were made using the DuNuoy Ring tensiometer method. The DuNuoy Ring tensiometer (Fisher Model 20 manual DuNuoy Ring Tensiometer or CSC Model 70535) may be obtained from Fisher Scientific or CSC Scientific Co., Fairfax, Va. or from companies such as Cole Palmer or VWR. Absorbance measurements were obtained with a Perkin Elmer Lambda 2 UV/Visible Spectrometer. Specific gravity was measured with a weight per gallon cup which meets ASTM methods. A weight per gallon cup accommodates 8.321 grams of water at 77.0° F. (25° C.). The apparent pH values were read directly from an Orion Model 420A electronic pH meter with an Orion 91-55 electrode, after calibrating the instrument with appropriate buffers and immersing the electrode into the flavored fluids.

SDI measurements were obtained using a modified ASTM D4189-82 protocol for SDI of water. SDI testing is a method that relates the rate of membrane plugging or clogging to the quantity of particulate matter in the fluid. In the modified procedure, designated “Heat Test SDI” in the tables, a stainless steel filter funnel (25 mm, 50 ml bowl capacity) was placed over a 250 ml filter flask hooked up to a vacuum and a vacuum gauge. A Pall Versapor® 25 mm, 0.45 μm membrane filter disk was placed in the filter funnel and pre-moistened with a few drops of the fluid to be tested. The vacuum pressure was set to 23 in. of mercury. The fluid to be tested was heat aged for 11 days at 70° C. Heat-aging is not necessary to determine the SDI of the flavored fluids. SDI may be measured substantially immediately after the flavored fluids are prepared. In these experiments, the flavored fluids were heat-aged in order to test the shelf life of the fluids. A high SDI index after the aging process indicates that significant particle formation does not occur and indicates a long shelf life for the fluids.

After heat-aging, 20 ml of the heat-aged fluid to be tested was poured into the filter funnel and a stopwatch (with a resolution of hundredths of a second) was used to measure the time required for the fluid to pass through the filter. This time was recorded as “T₁.” A 160 ml aliquot of the heat-aged fluid to be tested was then poured into the filter funnel and allowed to pass through the filter. Although the time required for this second aliquot to pass through the filter need not be recorded, it is designated “T₂.” Next, a second 20 ml aliquot of the heat-aged liquid to be tested was poured into the filter funnel and the time required for the fluid to pass through the filter was measured with the stopwatch. This time was recorded as “T₃.” SDI is then calculated by dividing T₁ by T₃.

### Example 1

### Preparation of Ink-Jettable Flavored Fluids

This example describes a method for producing non-aqueous food grade flavored fluids from food grade flavors. Seventeen illustrative fluids and flavors for these fluids are shown in Tables 1-5. The flavored fluids were prepared as follows. All ingredients, except the flavor components, were mixed together in a container approved for food use for about 30 to 60 minutes. The resultant solution was then filtered through a 0.2 μm filter. The filtrate was removed to a fume hood where the flavor component was then added. The filtrate and flavored component were stirred together for about 30 minutes to obtain the flavored fluid. The flavored fluid was then filtered with a 0.5 μm filter. The amount of each component making up the flavored fluid is given in wt. %.

TABLE 1

| | SAMPLE | SAMPLE | SAMPLE | SAMPLE |
|---|---|---|---|---|
| | A1 | A2 | B1 | B2 |
| 1,2-Propanediol | 94.2 | 93.4 | 93.4 | 89.4 |
| Glycerine | 4.0 | 4.0 | 4.0 | 4.0 |
| FD&C Blue #1 | 1.6 | 1.6 | 1.6 | 1.6 |
| Balls of Fire | 0.2 | 1.0 | | |
| Flavor | | | | |
| Vanilla Flavor | | | 1.0 | 5.0 |
| pH | 5.27 | 4.69 | | 5.46 |
| Viscosity | 55.4 | 54.0 | | 48.4 |
| (centipoises) | | | | |
| Surface Tension | 39.0 | 39.9 | | 39.9 |
| (dynes/cm) | | | | |

TABLE 2

| | SAMPLE C1 | SAMPLE C2 | SAMPLE C3 |
|---|---|---|---|
| 1,2-Propanediol | 93.9 | 94.2 | 93.4 |
| Glycerine | 4.0 | 4.0 | 4.0 |
| FD&C Blue #1 | 1.6 | 1.6 | 1.6 |
| Strawberry Flavor | 0.5 | 0.5 | 1.0 |
| pH | | | 5.38 |
| Viscosity (centipoises) | | | 53.3 |
| Surface Tension (dynes/cm) | | | 40.0 |

TABLE 3

| | SAMPLE D1 | SAMPLE D2 | SAMPLE D3 |
|---|---|---|---|
| 1,2-Propanediol | 88.40 | 93.4 | 89.4 |
| Glycerine | 5.0 | 4.0 | 4.0 |
| FD&C Blue #1 | 1.6 | 1.6 | 1.6 |
| Sour Flavor | 5.0 | 5.0 | 20.0 |
| pH | 2.35 | 2.35 | 2.38 |
| Viscosity (centipoises) | 56.3 | 56.3 | 56.4 |
| Surface Tension | 40.2 | 40.2 | 41.0 |
| (dynes/cm) | | | |

TABLE 4

| | SAMPLE E | SAMPLE F | SAMPLE G |
|---|---|---|---|
| Propylene Glycol | 96.83 | 76.83 | 72.99 |
| Glycerine¹ | | 15.00 | 12.00 |
| 1 N NaOH | 0.01 | 0.16 | |
| FD&C Blue #1 | 0.16 | 0.01 | 0.01 |
| Balls of Fire | 3.00 | | |
| Banana Type Natural Flavor | | 8.00 | |
| Coolenol Flavor | | | 15.00 |
| pH | 6.2 | 6.9 | 5.50 |
| Viscosity at 50° C. | 14.00 | 14.00 | 15.80 |
| (centipoises) | | | |
| Surface Tension (dynes/cm) | 40.50 | 33.00 | 37.60 |

¹Glycerine is a 99.7% solution.

TABLE 5

| | SAMPLE | SAMPLE | SAMPLE | SAMPLE |
|---|---|---|---|---|
| | H | I | J | K |
| 1,2-Propanediol | 83.35 | 43.7 | 36.0 | 51.4 |
| Glycerine | 5.0 | 38.0 | 8.0 | 5.0 |
| Deionized Water | | 14.0 | | 10.0 |
| 11.7 N KOH | | | 2.0 | 30.0 |
| Sugar Syrup | | | | |
| Potassium Tricitrate | | | 4.0 | |
| FD&C Yellow #5 | 1.0 | | | |
| FD&C Blue #1 | 0.65 | | | 1.6 |
| FD&C Red 40 | | 1.3 | | |
| Caramel Color Liquid | | | 45.0 | |
| Sour Cream & Onion | 10.0 | | | |
| Flavor | | | | |
| Pizza Flavor | | 3.0 | | 20.0 |
| Sausage Flavor | | | 5.0 | |
| Strawberry Flavor | | | | 2.0 |
| pH | 4.14 | 3.44 | | 4.99 |
| Viscosity (centipoises) | 49.2 | 47.0 | | 64.3 |
| Surface Tension | 34.9 | 36.9 | | 47.0 |
| (dynes/cm) | | | | |

### Example 2

### Application of Food Grade Flavored Fluids to an Edible Substrate

Food grade flavored fluids can be printed through commercially available printing equipment employing printheads manufactured by manufacturers of piezo printheads such as Spectra, Xaar, Hitachi and PicoJet. When jetting Sample A1, for example, the printhead is set to 55° C. One example of a printhead which could be used for jetting these fluids is the NovaAAA jetting assembly 256/80 AQ, manufactured by Spectra. Inks successfully jet at frequencies including 1 kHz to 25 kHz. Based on the printhead design and fluid ingredients, fluids may be jettable up to a frequency of 40 kHz. For highest resolution a substrate gap of 1 mm may be desirable. Substrates such as cookies, crackers, breads, marshmallows, and other edible items in a wide variety of shapes and thickness may be jetted.

Flavored fluids can be formulated for a variety of end uses. In one embodiment, the flavored fluid imparts one or more flavors to a substrate in either a random or predetermined pattern using a printer. In another embodiment, the flavored fluid enhances the primary flavor of the edible substrate, such as printing chocolate flavor on a chocolate snack cake. In yet another embodiment, the flavored fluid provides a flavor different from the primary flavor of the edible substrate, such as printing strawberry flavor on chocolate. In a further embodiment, the flavored fluid provides surprise impact, such as printing hot or sour flavors on a salty snack.

In an additional embodiment, the flavored fluids impart a flavor image to the substrate using a printer. A flavor image combines taste appeal with visual appeal by printing flavored fluids having both a flavor component and a color component. One or more flavored fluids can be printed onto a substrate to produce a variety of images and patterns exhibiting one or more flavors and colors. The flavor component may have a direct correlation to the image, such as the image of an jalapeno pepper having a jalapeno flavor, or be completely unrelated, such as the image of a grape having a cinnamon flavor. In a further embodiment, the flavor components and color components are in separate fluids. Flavored fluids contain one or more flavor components. Colored fluids contain one or more colored components. Food grade colored fluids suitable for producing images on substrates can be found in U.S. application Ser. Nos. 10/601,064 filed Jun. 20, 2003, 10/918,197 filed Aug. 13, 2004 and 11/149,665 filed Jun. 10, 2005, each of which is hereby fully incorporated by reference. The flavor image is produced by printing at least one flavored fluid and at least one colored fluid onto a substrate either simultaneously or sequentially. When the fluids are printed sequentially, either the colored fluid or the flavored fluid may be printed first. The fluids may be printed onto the substrate in either a random or predetermined pattern using a printer.

Examples of the various embodiments include: printing sweet, sour, hot, spicy or honey flavors on a potato chip; printing strawberry, chocolate or citrus flavors on snack cakes; printing sweet, sour, cool or mint flavors on candy products; printing smoky, barbeque, spicy or wasabi on processed food products; printing a bacon flavor onto a dog treat; printing a cheese flavor onto one-half of a cracker and a garlic flavor onto the other one-half of the cracker; printing a strawberry flavor onto one-third of an ice cream bar, a chocolate flavor onto another one-third of the ice-cream bar, and a vanilla flavor onto the remaining one-third of the ice-cream bar; printing a mystery flavor (e.g., apple flavor) onto a colorless, gelatin-based roll-up; printing a strawberry flavor and the image of a strawberry onto a cookie; printing a spicy hot flavor and the image of a volcano onto a slice of bologna; and printing a sour cream & onion flavor and the image of a jalapeno pepper onto a potato chip.

In some embodiments, the flavored fluids (or flavor images) are used to enhance or alter the flavor of the edible substrate. For example, a strawberry flavor fluid is applied to a snack cake. When the consumer eats the snack cake, he senses the strawberry flavor as part of consuming the edible substrate. In other embodiments, the flavored fluids (or flavor images) are used to provide a secondary sensory experience. The consumer licks the flavored fluid (or flavor image) off the edible substrate prior to its consumption. The flavored fluid (or flavor image) provides a secondary flavor that is separate from any flavor associated with eating the substrate. In yet other embodiments, the flavored fluids (or flavor images) are used to provide a secondary flavor and enhance the flavor of the edible substrate.

### Example 3

The food grade flavored fluids in Table 6 are particularly well-suited to valve jet printing methods. The amount of each component making up the flavored fluid is given in wt. %.

TABLE 6

| | SAMPLE L | SAMPLE M |
|---|---|---|
| Water | 50.08 | 53.75 |
| Tangerine HSE | 20 | |
| Propylene Glycol | 16.32 | 20 |
| Citric Acid Powder | 10.16 | 15 |
| Sucrose | 3.04 | 10 |
| Acesulfame Potassium (ACE K) | 0.2 | 1.0 |
| Sodium Benzoate | 0.2 | 0.25 |

### Example 4

Another food grade flavored fluid with potential applicability to valve jet printing comprises 57.25 wt. % water, 25 wt. % propylene glycol, 12.5 wt. % citric acid, 5.0 wt. % sucralose, and 0.25 wt. % sodium benzoate.

### Example 5

### Application of a Secondary Flavored Fluid to an Edible Substrate

In reference to Example 2, flavored fluids can be printed through commercially available printing equipment employing printheads and subsequently a second flavored fluid can be applied by precision deposition. Substrates such as cookies, crackers, breads, marshmallows, and other edible items in a wide variety of shapes and thickness may be jetted a first flavored fluid and sprayed a second flavored fluid to add another flavor experience.

In some embodiments, a printer imparts one or more flavored fluids to a substrate. In these applications, A USMR Micro-Spray Markers (available from UNIVERSAL STENCILING & MARKING SYSTEMS, St. Petersburg, Fla.) may apply one or more flavored fluid different from the ones imparted by the printer. For example, one or more flavored fluids can be printed onto a substrate to produce a variety of images and patterns and the spray marker can apply an additional flavored fluid related to the printed image or complementary to the printed image. One example includes printing the image of a jalapeno pepper and spraying or precision depositing a jalapeno flavor. The flavor component may have a direct correlation to the image, such as the image of the jalapeno pepper having a jalapeno flavor, or be completely unrelated, such as the image of a grape having a cinnamon flavor. Another example includes printing an image of a strawberry and spraying or precision depositing a chocolate flavor on the printed image, or a portion thereof.

### Example 6

The composition comprised the sweetener/acid base below with the addition of a Lemon Flavor (percentages are given in wt. %).

| Ingredients | % |
|---|---|
| Water, Reverse Osmosis | 82.4706 |
| Potassium Benzoate | 0.0318 |
| Potassium Sorbate, Granular | 0.0168 |
| Potassium Citrate | 5.5485 |
| Sucralose 81600 PWD | 0.4709 |
| Acesulfame K | 0.099 |
| Citric Acid Anhydrous | 11.3624 |
| Total | 100.0000 |

K07328-Acesulfame K was obtained from Nutrinova, K12730-Sucralose 81600 PWD was obtained from Tate & Lyle, and the K07639-Citric acid solution (50%) was obtained from Cargill and Jungbunzlauer. Valve jet technology was used to jet the formulation onto a processed fruit snack, particularly, a Fruit Roll-Up Fruits Snack® (General Mills).

### Example 7

Using precision deposition, 0.7898 mL of each of the formulations in Examples 1, 3, 4, and 6 is sprayed onto a variety of edible substrates (e.g., roll-up snacks, snack cakes, and gums). The USMR Micro-Spray Marker, available from UNIVERSAL STENCILING & MARKING SYSTEMS (St. Petersburg, Fla.), is set to an atomizing air pressure of 15 PSI and the spraying aperture is set to spray a 0.75″ diameter. The edible substrate is static, and the spray duration is 800 milliseconds. The spray head is held 2-3″ from the edible substrate during deposition.

### Example 8

Example 7 is followed except pressures ranging from 18-24 PSI are tested at 1 PSI intervals.

### Example 9

Using precision deposition, 0.7249 mL of each of the formulations in Examples 1, 3, 4, and 6 is sprayed onto a variety of edible substrates (e.g., roll-up snacks, snack cakes, and gums). The USMR Micro-Spray Marker, available from UNIVERSAL STENCILING & MARKING SYSTEMS (St. Petersburg, Fla.), is set to an atomizing air pressure of 15 PSI and the spraying aperture is set to spray a 0.75″ diameter. The edible substrate is static, and the spray duration is 800 milliseconds. The spray head is held 2-3″ from the edible substrate during deposition.

### Example 10

Example 9 is followed except pressures ranging from 18-24 PSI are tested at 1 PSI intervals.

### Example 11

The strawberry flavor in Table 2 of Example 1 is precision deposited to the following using the technique of Example 7: chocolate; snack cakes; an ice cream bar (with or without other flavors such as chocolate and vanilla); an edible image of a strawberry on a cookie; cookies such as chocolate or chocolate chip cookies; and other flavors such as chocolate or vanilla onto a chocolate cookies.

### Example 12

The strawberry flavor in Table 5 of Example 1 is precision deposited to the following using the technique of Example 9: chocolate; snack cakes; an ice cream bar (with or without other flavors such as chocolate and vanilla); an edible image of a strawberry on a cookie; cookies such as chocolate or chocolate chip cookies; and other flavors such as chocolate or vanilla onto a chocolate cookies.

### Example 13

The vanilla flavor in Table 1 of Example 1 is precision deposited using the technique of Example 7 onto ice cream (with or without other flavors such as chocolate and vanilla) and cookies (without or without other flavors such as chocolate and vanilla).

### Example 14

The sour flavor in Table 3 of Example 1 is precision deposited using the technique of Example 9 onto a salty snack; a potato chip; candy products; and the center of a starburst image on a gelatin-based roll-up.

### Example 15

The sour cream & onion flavor in Table 5 of Example 1 is precision deposited using the technique of Example 7 onto a potato chip and the image of a jalapeno pepper on a potato chip.

### Example 16

The magenta and red edible inks set forth in Examples 19, 21, 22, 23, 31, 32 are ink jetted onto a commercial potato chip using the technique set forth in Example 24 to form an edible image of a flame. The balls of fire flavored fluids of Example 1 are precision deposited using USMR Micro-Spray Markers available from UNIVERSAL STENCILING & MARKING SYSTEMS (St. Petersburg, Fla.) according to the technique according to Example 7. The flavored fluids are deposited 1) before ink jetting of the image; and 2) after ink jetting of the image.

### Example 17

The yellow edible inks set forth in Examples 19, 20, 21, 22, 23, 31, 32, are ink jetted onto a marshmallow using the technique set forth in Example 24 to form an edible image of a banana. The banana flavored fluids of Example 1 are precision deposited using USMR Micro-Spray Markers available from UNIVERSAL STENCILING & MARKING SYSTEMS (St. Petersburg, Fla.) according to the technique according to Example 9. The flavored fluids are deposited 1) before ink jetting of the image; and 2) after ink jetting of the image. In another embodiment, the edible image of the banana is ink jet printed onto a banana flavored snack cake, and the banana flavored fluids are precision deposited specifically onto the image to provide an extra burst of banana flavor. The flavored fluids may be precision deposited before or after the image is ink jet printed.

### Example 18

The blue and cyan edible inks set forth in Examples 19, 20, 21, 22, 23, 25, 26, 27, 28, 29, 30, 31, 32, 33, 34, 35, 36, 37, 38, 39, 40, 41, 42, 43, 44, 45, 46, 47, 48, and 49 are ink jetted onto a bagel using the technique set forth in Example 24 to form the image of blueberries. The strawberry flavored fluids of Example 1 are precision deposited using USMR Micro-Spray Markers available from UNIVERSAL STENCILING & MARKING SYSTEMS (St. Petersburg, Fla.) according to the technique according to Example 7. Accordingly, the image and the flavor do not correlate, providing an element of surprise or novelty. The flavored fluids are deposited 1) before ink jetting of the image; and 2) after ink jetting of the image.

Instrumentation and Measurements for Examples 19-49

Examples 19 through 23 below provide examples of various food grade colored fluids. The formulations (in weight percent) and several physical characteristics of the fluids of Examples 19 through 23 are provided in Tables 7-13. The physical characteristics presented in the tables were measured as follows. Viscosity measurements were obtained using a Brookfield Programmable LVDV II⁺ Digital Calculating Viscometer and a Brookfield DV III Rheometer Model V3.3LV with ULA spindle manufactured by Brookfield Engineering Laboratories, Inc., Middleboro, Mass. Surface tension measurements were made using the DuNuoy Ring tensiometer method. The DuNuoy Ring tensiometer (Fisher Model 20 manual DuNuoy Ring Tensiometer or CSC Model 70535) may be obtained from Fisher Scientific or CSC Scientific Co., Fairfax, Va. or from companies such as Cole Palmer or VWR. Absorbance measurements were obtained with a Perkin Elmer Lambda 2 UV/Visible Spectrometer. Specific gravity was measured with a weight per gallon cup which meets ASTM methods. A weight per gallon cup accommodates 8.321 grams of water at 77° F. (25° C.). The apparent pH values were read directly from an Orion Model 420A electronic pH meter with an Orion 91-55 electrode, after calibrating the instrument with appropriate buffers and immersing the electrode into the colored fluids.

SDI measurements were obtained using a modified ASTM D4189-82 protocol for SDI of water. SDI testing is a method that relates the rate of membrane plugging or clogging to the quantity of particulate matter in the fluid. In the modified procedure, designated “Heat Test SDI” in the tables, a stainless steel filter funnel (25 mm, 50 ml bowl capacity) was placed over a 250 ml filter flask hooked up to a vacuum and a vacuum gauge. A Pall Versapor® 25 mm, 0.45 μm membrane filter disk was placed in the filter funnel and pre-moistened with a few drops of the fluid to be tested. The vacuum pressure was set to 23 in. of mercury. The fluid to be tested was heat aged for 11 days at 70° C. Heat-aging is not necessary to determine the SDI of the colored fluids. SDI may be measured substantially immediately after the colored fluids are prepared. In these experiments, the colored fluids were heat-aged in order to test the shelf life of the fluids. A high SDI index after the aging process indicates that significant particle formation does not occur and indicates a long shelf life for the fluids.

After heat-aging, twenty ml of the heat-aged fluid to be tested was poured into the filter funnel and a stopwatch (with a resolution of hundredths of a second) was used to measure the time required for the fluid to pass through the filter. This time was recorded as “T₁” A 160 ml aliquot of the heat-aged fluid to be tested was then poured into the filter funnel and allowed to pass through the filter. Although the time required for this second aliquot to pass through the filter need not be recorded, it is designated “T₂.” Next, a second 20 ml aliquot of the heat-aged liquid to be tested was poured into the filter funnel and the time required for the fluid to pass through the filter was measured with the stopwatch. This time was recorded as “T₃.” SDI is then calculated by dividing T₁ by T₃.

Unless stated otherwise, percentages are given as weight percentages.

### Example 19

### Preparation of Non-Aqueous Food Grade Colored Fluids

This example describes a method for producing non-aqueous food grade colored fluids from food grade FD&C dyes, 1,2-propanediol and glycerine. Three illustrative formulations and colors for these formulations are shown in Table 7. The colored fluids were prepared as follows. The 1,2-propanediol, glycerine, methylparaben and propylparaben were mixed together in a container approved for food use at 50° C. for approximately 20 minutes. The FD&C dyes were then added while mixing, the heater was turned off, and mixing continued for about one hour. Next the isopropanol was added, the mixing continued for another ten minutes and the mixture was allowed to cool to ambient temperature. The resulting colored fluid was then filtered with a 0.2 μm filter.

TABLE 7
Non-aqueous Food Grade Colored Fluid Formulations

| | SAMPLE A | SAMPLE B | SAMPLE C |
|---|---|---|---|
| Color | Blue (Cyan) | Magenta | Yellow |
| 1,2-propanediol | 92.33 | 89.49 | 89.93 |
| Methylparaben | 0.05 | 0.05 | 0.05 |
| Propylparaben | 0.02 | 0.02 | 0.02 |
| Glycerine | 4.00 | 6.00 | 6.00 |
| FD&C Blue 1 | 1.60 | 0.008 | |
| FD&C Red 3 | | 2.30 | |
| FD&C Red 40 | | 0.130 | |
| FD&C Yellow 5 | | | 2.30 |
| Isopropanol | 2.00 | 2.00 | 2.00 |
| Surface Tension (dynes/cm) | 39.6 | 39.1 | 38.4 |
| Viscosity (centipoise) | 54.2 | 53.5 | 58.2 |
| Heat Test SDI | 0.96 | 0.99 | 0.998 |
| Apparent pH | 4.89 | 8.48 | 6.86 |
| Absorbance | 0.569 (@ 629 nm) | 0.613 (@ 526 nm) | 0.569 (@ 427 nm) |
| Specific Gravity | 1.0493 | 1.0638 | 1.0638 |

Each of the FD&C dyes listed in Tables 7-9 and 11-13 are available from Sensient Colors, Inc., St. Louis, Mo.

### Example 20

### Preparation of Low Water Content Food Grade Colored Fluids

This example describes a method for producing low water content food grade colored fluids from food grade FD&C dyes, 1,2-propanediol and glycerine. Seven illustrative formulations and colors for these formulations are shown in Tables 8 and 9. The colored fluids were made according to the procedure described in Example 19 above, with the exception that the water and any sodium hydroxide present were added during the initial mixing step.

TABLE 8
Low Water Content Food Grade Colored Fluid Formulations

| | SAMPLE D | SAMPLE E | SAMPLE F | SAMPLE G |
|---|---|---|---|---|
| Color | Red | Yellow | Green | Blue |
| 1,2-propanediol | 41.685 | 43.933 | 41.94 | 41.85 |
| Glycerine | 38.00 | 38.00 | 38.00 | 38.00 |
| DI Water | 16.00 | 14.00 | 16.00 | 16.00 |
| 1 N NaOH | | | 0.060 | |
| FD&C Blue 1 | 0.015 | 0.025 | 0.80 | 1.60 |
| FD&C Red 3 | 1.00 | | | 0.55 |
| FD&C Red 40 | 1.30 | 0.042 | | |
| FD&C Yellow 5 | | 2.00 | 1.20 | |
| Isopropanol | 2.00 | 2.00 | 2.00 | 2.00 |
| Surface Tension | 44.8 | 43.8 | 44.1 | 45.1 |
| (dynes/cm) | | | | |
| Viscosity | 40.0 | 46.6 | 40.3 | 41.4 |
| (centipoise) | | | | |
| Heat Test SDI | 0.99 | 0.83 | 0.88 | 0.90 |
| Apparent pH | 7.58 | 6.89 | 6.65 | 6.03 |
| Absorbance | 0.824 (@ 525 nm) | 0.529 (@ 426 nm) | 0.675 (@ 629 nm) | 0.665 (@ 629 nm) |
| | | | 0.357 (@ 412 nm) | |
| Specific Gravity | 1.13 | — | 1.123 | 1.1263 |

TABLE 9
Low Water Content Food Grade Colored Fluid Formulations

| | SAMPLE H | SAMPLE I | SAMPLE J |
|---|---|---|---|
| Color | Black | Black | Brown |
| 1,2-propanediol | 42.88 | 43.55 | 42.54 |
| Methylparaben | 0.05 | | 0.05 |
| Propylparaben | 0.02 | | 0.02 |
| Glycerine | 38.00 | 38.00 | 40.00 |
| DI Water | 14.00 | 14.00 | 13.00 |
| 1 N NaOH | 0.05 | 0.05 | |
| FD&C Yellow 6 | 0.35 | 0.28 | |
| FD&C Blue 1 | 0.96 | 0.77 | 0.18 |
| FD&C Red 40 | 1.69 | 1.35 | 1.28 |
| FD&C Yellow 5 | | | 0.93 |
| Isopropanol | 2.00 | 2.00 | 2.00 |
| Surface Tension (dynes/cm) | 45.0 | 44.5 | 44.0 |
| Viscosity (centipoise) | 47.1 | 47.2 | 51.9 |
| Heat Test SDI | 0.81 | 0.85 | 0.62 |
| Apparent pH | 6.74 | 6.95 | 6.19 |
| Absorbance | 0.790 (@ 629 nm) | 0.610 (@ 629 nm) | 0.295 (@ 629 nm) |
| | 0.590 (@ 504 nm) | 0.436 (@ 504 nm) | 0.717 (@ 494 nm) |
| | 0.246 (@ 409 nm) | 0.191 (@ 409 nm) | 0.689 (@ 426 nm) |
| Specific Gravity | 1.1259 | 1.127 | 1.1287 |

### Example 21

### Preparation of Food Grade Colored Fluids from Natural Dyes

This example describes a method for producing food grade colored fluids from food grade natural dyes, 1,2-propanediol and glycerine. Four illustrative formulations and colors for these formulations are shown in Table 10. The colored fluids were made according to the procedure described in Example 19 above, with the exception that any water present was added in the initial mixing step and the natural dyes were added in the second mixing step, rather than the FD&C dyes.

TABLE 10
Food Grade Colored Fluid Formulations Made From Natural Dyes

| | SAMPLE K | SAMPLE L | SAMPLE M | SAMPLE N |
|---|---|---|---|---|
| Color | Red | Yellow | Yellow | Blue |
| 1,2-propanediol | 59.5 | 39.7 | 42.0 | 24.0 |
| Glycerine | 6.00 | 6.0 | 6.0 | 4.0 |
| DI Water | | 50.0 | | 50.0 |
| Carminic Acid | 32.5 | | | |
| (7.5%) liquid^{a} | | | | |
| Gardenia Yellow^{b} | | 2.0 | | |
| Turmeric Liquid^{c} | | | 50.0 | |
| Gardenia Blue^{d} | | | | 20.0 |
| Isopropanol | 2.00 | 2.00 | 2.00 | 2.00 |
| Surface Tension | 41.7 | 46.3 | 37.1 | 46.4 |
| (dynes/cm) | | | | |
| Viscosity (centipoise) | 18.4 | 5.92 | 38.0 | 13.1 |
| Apparent pH | 7.42 | 3.96 | 4.67 | 5.62 |
| Absorbance | 0.718 (@ 556 nm) | 0.394 (@ 438 nm) | 0.368 (@ 425 nm) | 0.929 (@ 596 nm) |
| | 0.694 (@ 527 nm) | | | |
| Specific Gravity | 1.064 | 1.054 | 1.035 | 1.113 |

^{a}A natural food dye obtained from Sensient Colors, Inc., containing 7.5 wt. % cochineal in propylene glycol.
^{b}A natural food dye obtained from Sensient Colors, Inc.
^{c}A natural food dye obtained from Sensient Colors, Inc., containing 7.7 wt. % ethyl alcohol, 90.8 wt. % propylene glycol and 1.5 wt. % oleoresin turmeric which itself contains 48-50 wt. % curcumin with a balance of flavor and gum components
^{d}A natural food dye obtained from Sensient Colors, Inc.

### Example 22

### Preparation of Low Inorganic Salt Content Food Grade Colored Fluids

This example describes a method for producing low inorganic salt content food grade colored fluids from low salt food grade FD&C dyes, 1,2-propanediol and glycerine. Three illustrative formulations and colors for these formulations are shown in Table 11. The colored fluids were made according to the procedure described in Example 19 above.

TABLE 11
Low Inorganic Sale Content Colored Fluid Formulations

| | SAMPLE O | SAMPLE P | SAMPLE Q |
|---|---|---|---|
| Color | Yellow | Blue (Cyan) | Blue (Blue) |
| 1,2-propanediol | 91.80 | 92.33 | 91.78 |
| Glycerine | 4.00 | 4.00 | 4.00 |
| Methylparaben | | 0.05 | 0.05 |
| Propylparaben | | 0.02 | 0.02 |
| Low Salt FD&C Blue 1^{e} | | 1.60 | 1.60 |
| FD&C Red 3 | | | 0.55 |
| Low Salt FD&C Yellow 5^{f} | 2.20 | | |
| Isopropanol | 2.00 | 2.00 | 2.00 |
| Surface Tension (dynes/cm) | 39.6 | 39.2 | 39.4 |
| Viscosity (centipoise) | 53.9 | 49.5 | 50.4 |
| Heat Test SDI | — | 0.51 | 0.82 |
| Apparent pH | 7.84 | 5.53 | 7.75 |
| Absorbance | 0.593 (@ 428 nm) | 0.973 (@ 629 nm) | 0.677 (@ 629 nm) |
| | | | 0.168 (@ 526 nm) |
| Specific Gravity | 1.0505 | 1.0493 | 1.0529 |

^{e}The formulation for this low salt blue dye is presented in Table 1, above.
^{f}The formulation for this low salt yellow dye is presented in Table 1, above.

### Example 23

### Preparation of Low Viscosity Food Grade Colored Fluids

This example describes a method for producing low viscosity food grade colored fluids from food grade FD&C dyes, 1,2-propanediol and glycerine. Three illustrative formulations and colors for these formulations are shown in Tables 12 and 13. The colored fluids were prepared as follows. The 1,2-propanediol, glycerine, water and Docusate sodium were mixed together at 40° C. for approximately 20 minutes. The FD&C dyes were then added while mixing, the heater was turned off, and mixing continued for about one hour. The mixture was allowed to cool to ambient temperature. The resulting colored fluid was then filtered with a 0.2 μm filter.

TABLE 12
Low Viscosity Food Grade Colored Fluid Formulations

| | SAMPLE R | SAMPLE S | SAMPLE T |
|---|---|---|---|
| Color | Cyan | Cyan | Cyan |
| 1,2-propanediol | 50.0 | 49.3 | 70.0 |
| DI water | 41.9 | 33.0 | 23.9 |
| Glycerine | 5.0 | 14.0 | 3.0 |
| 1% Docusate sodium | 1.5 | 0 | 1.5 |
| 1.0 N NaOH | 0 | 0.10 | 0 |
| FD&C Blue 1 | 1.6 | 1.6 | 1.6 |
| Isopropanol | 0 | 2.0 | 0 |
| Surface Tension | 48.0 | 44.0 | 44.4 |
| (dynes/cm) | | | |
| Viscosity (centipoise) | 7.62 | 11.4 | 14.8 |
| SDI | | 0.92 | |
| Apparent pH | 5.51 | 5.76 | 5.24 |
| Absorbance | — | 0.665 (@ 629 nm) | |
| Specific Gravity | — | 1.071 | |

TABLE 13
Low Viscosity Food Grade Colored Fluid Formulations

| | SAMPLE U | SAMPLE V | SAMPLE W |
|---|---|---|---|
| Color | Magenta | Yellow | Black |
| 1,2-propanediol | 49.609 | 49.23 | 47.83 |
| Methylparaben | 0.05 | 0.05 | 0.05 |
| Propylparaben | 0.02 | 0.02 | 0.02 |
| Glycerine | 14.0 | 14.0 | 14.0 |
| DI Water | 32.0 | 32.5 | 33.0 |
| FD&C Blue | 0.008 | | 0.96 |
| FD&C Red 3 | 2.30 | | |
| FD&C Red 40 | 0.013 | | 1.69 |
| FD&C Yellow 5 | | 2.20 | |
| FD&C Yellow 6 | | | 0.35 |
| Isopropanol | 2.0 | 2.0 | 2.0 |
| Surface Tension (dynes/cm) | 44.5 | 44.2 | 44.6 |
| Viscosity (centipoise) | 11.5 | 12.0 | 11.8 |
| pH | 8.43 | 6.44 | 7.48 |
| Absorbance | 0.633 (@ 526 nm) | 0.547(@ 425 nm) | 0.408 (@ 629 nm) |
| Specific Gravity | 1.083 | 1.076 | 1.0818 |
| Heat Test SDI | | | |

### Example 24

### Application of Food Grade Colored Fluids to an Edible Substrate

This Colored fluids can be printed through commercially available printing equipment employing printheads manufactured by manufacturers of piezo printheads such as Spectra, Xaar, Hitachi and PicoJet. When jetting Sample P, for example, the printhead is set to 60° C. One example of a printhead which could be used for jetting these fluids is the NovaQ jetting assembly 256/80 AQ, manufactured by Spectra. Inks successfully jet at frequencies including, but not limited to, 1 kHz to 20 kHz. Based on the printhead design and ink ingredients (formulations) inks may be jettable up to a frequency of 40 kHz. For highest resolution a substrate gap of 1 mm may be desirable. Substrates such as cookies, crackers, breads, marshmallows, and other edible items in a wide variety of shapes and thickness may be jetted.

### Example 25

### Preparation of Low Surface Tension Food Grade Colored Fluids Containing a Sorbitan Ester Surface Tension Modifier

This example describes a method for producing food grade colored fluids from a low chloride food grade FD&C dye, 1,2-propanediol, glycerine and Tween® 80, a polyoxyethylene sorbitan monooleate surface tension modifier; Tween® 65, a polyoxyethylene sorbitan tristearate; and Tween® 60, a polyoxyethylene sorbitan monostearate. The formulations for the food grade colored fluids are provided in Table 14. The 1,2-propanediol, glycerine, Tween®, and deionized water were mixed together in a container approved for food use at 40° C. for approximately 10 minutes. The FD&C dye was then added while mixing at 40° C. for approximately 30 minutes. The resulting mixture was then filtered with a 0.2 μm filter. Next the isopropanol was added, the mixing continued for another ten minutes.

TABLE 14
Low Surface Tension Food Grade Colored Fluid Formulations

| | SAMPLE X | | | SAMPLE |
|---|---|---|---|---|
| | (CONTROL) | SAMPLE Y | SAMPLE Z | AA |
| Color | Blue (Cyan) | Blue (Cyan) | Blue (Cyan) | Blue (Cyan) |
| 1,2-propanediol | 66.4 | 66.3 | 66.3 | 66.3 |
| Glycerine | 5 | 5 | 5 | 5 |
| Tween ® 80 | | 0.1 | | |
| Tween ® 65 | | | 0.1 | |
| Tween ® 60 | | | | 0.1 |
| Deionized Water | 25 | 25 | 25 | 25 |
| FD&C Blue 1 (low Cl⁻, Table 1) | 1.60 | 1.60 | 1.60 | 1.60 |
| Isopropanol | 2.00 | 2.00 | 2.00 | 2.00 |
| Surface Tension | 43.2 | 31 | 42.5 | 37 |
| (dynes/cm at 25° C.) | | | | |

### Example 26

### Preparation of Low Surface Tension Food Grade Colored Fluids Containing a Fatty Acid Surface Tension Modifier

This example describes a method for producing food grade colored fluids from a low chloride food grade FD&C dye, 1,2-propanediol, glycerine and Sylfat® FA-1, a surface tension modifier composed of a mixture of oleic and linoleic fatty acids. The formulations for the food grade colored fluids are provided in Table 15. The 1,2-propanediol, glycerine, deionized water and NaOH were mixed together in a container approved for food use at 40° C. for approximately 10 minutes. The FD&C dye was then added while mixing at 40° C. for approximately one hour. The resulting mixture was then filtered with a 0.2 μm filter. Finally, the Sylfat® FA-1 was added to the mixture.

TABLE 15
Low Surface Tension Food Grade Colored Fluid Formulations

| | SAMPLE BB | SAMPLE CC |
|---|---|---|
| Color | Blue (Cyan) | Blue (Cyan) |
| 1,2-propanediol | 90.06 | 87.75 |
| Glycerine | 3.9 | 3.8 |
| NaOH | 0.03 | 0.03 |
| Deionized Water | 1.95 | 1.90 |
| FD&C Blue I (low C1⁻, Table 1) | 1.56 | 1.52 |
| Sylfat ® F A-1 | 2.5 | 5.0 |
| Surface Tension (dynes/cm at 25° C.) | 36.4 | 36.4 |

### Example 27

### Preparation of Low Surface Tension Food Grade Colored Fluids Containing a Polyglycerol Ester Surface Tension Modifier

This example describes a method for producing food grade colored fluids from a low chloride food grade FD&C dye, 1,2-propanediol, glycerine and Santone® 8-1-0, a octaglycerol monooleate surface tension modifier. The formulations for the food grade colored fluids are provided in Table 16. The 1,2-propanediol, glycerine, deionized water and NaOH were mixed together in a container approved for food use at 40° C. for approximately 10 minutes. The FD&C dye was then added while mixing at 40° C. for approximately one hour. The resulting mixture was then filtered with a 0.2 μm filter. Finally, the Santone® 8-1-0 was added to the mixture.

TABLE 16
Low Surface Tension Food Grade Colored Fluid Formulations

| | SAMPLE DD | SAMPLE EE |
|---|---|---|
| Color | Blue (Cyan) | Blue (Cyan) |
| 1,2-propanediol | 91.9 | 92.27 |
| Glycerine | 3.98 | 4 |
| NaOH | 0.03 | 0.03 |
| Deionized Water | 2 | 2 |
| FD&C Blue 1 (low C1⁻, Table 1) | 1.59 | 1.6 |
| Santone ® 8-1-0 | 0.5 | 0.1 |
| Surface Tension (dynes/cm at 25° C.) | 35.8 | 36.4 |

### Example 28

### Preparation of Low Surface Tension, Low Water Content Food Grade Colored Fluids Containing a Sorbitan Ester Surface Tension Modifier

This example describes a method for producing food grade colored fluids from a low chloride food grade FD&C dye, 1,2-propanediol, glycerine and Tween® 80, a polyoxyethylene sorbitan monooleate surface tension modifier. The formulations for the food grade colored fluids are provided in Table 17. The 1,2-propanediol, glycerine, deionized water and NaOH were mixed together in a container approved for food use at 40° C. for approximately 10 minutes. The FD&C dye was then added while mixing at 40° C. for approximately one hour. The resulting mixture was then filtered with a 0.2 μm filter. Finally, the Tween® 80 was added to the mixture.

TABLE 17
Low Surface Tension Food Grade Colored Fluid Formulations

| | SAMPLE FF | SAMPLE GG | SAMPLE HH | SAMPLE II |
|---|---|---|---|---|
| Color | Blue (Cyan) | Blue (Cyan) | Blue (Cyan) | Blue (Cyan) |
| 1,2-propanediol | 92.27 | 91.9 | 91.45 | 87.75 |
| Glycerine | 4 | 3.98 | 3.96 | 3.8 |
| NaOH | 0.03 | 0.03 | 0.03 | 0.03 |
| Deionized Water | 2 | 2 | 1.98 | 1.90 |
| FD&C Blue 1 | 1.6 | 1.59 | 1.58 | 1.52 |
| (low C1⁻, Table 1) | | | | |
| Tween ® 80 | 0.1 | 0.5 | 1.0 | 5.0 |
| Surface Tension | 41 | 39.6 | 39.2 | 38.5 |
| (dynes/cm at 25° C.) | | | | |

### Example 29

### Preparation of Low Surface Tension, Low Water Content Food Grade Colored Fluids Containing a Sorbitan Ester Surface Tension Modifier

This example describes a method for producing food grade colored fluids from a low chloride food grade FD&C dye, 1,2-propanediol, glycerine and Tween® 60, a polyoxyethylene sorbitan monostearate surface tension modifier and Tween® 65, a polyoxytheylene sorbitan tristearate surface tension modifier. The formulations for the food grade colored fluids are provided in Table 18. The 1,2-propanediol, glycerine, deionized water and NaOH were mixed together in a container approved for food use at 40° C. for approximately 10 minutes. The FD&C dye was then added while mixing at 40° C. for approximately one hour. The resulting mixture was then filtered with a 0.2 μm filter. Next the isopropanol was added and the mixing continued. Finally, the Tween® was added to the mixture.

TABLE 18
Low Surface Tension Food Grade Colored Fluid Formulations

| | SAMPLE JJ | SAMPLE KK |
|---|---|---|
| Color | Blue (Cyan) | Blue (Cyan) |
| 1,2-propanediol | 89.47 | 89.47 |
| Glycerine | 3.96 | 3.96 |
| NaOH | 0.03 | 0.03 |
| Deionized Water | 1.98 | 1.98 |
| FD&C Blue 1 (low C1⁻, Table 1) | 1.58 | 1.58 |
| Isopropanol | 1.98 | 1.98 |
| Tween ® 60 | 1.0 | |
| Tween ® 65 | | 1.0 |
| Surface Tension (dynes/cm at 25° C.) | 37.5 | 39.1 |

### Example 30

### Preparation of Low Surface Tension, Low Water Content Food Grade Colored Fluids Containing a Lecithin Surface Tension Modifier

This example describes a method for producing food grade colored fluids from a low chloride food grade FD&C dye, 1,2-propanediol, glycerine and Yelkin® 1018, a hydroxylated lecithin surface tension modifier. The formulations for the food grade colored fluids are provided in Table 19. The 1,2-propanediol, glycerine, deionized water and NaOH were mixed together in a container approved for food use at 40° C. for approximately 10 minutes. The FD&C dye was then added while mixing at 40° C. for approximately one hour. The resulting mixture was then filtered with a 0.2 μm filter. Next the isopropanol was added and the mixing continued. Finally, the Yelkin® 1018 was added to the mixture.

TABLE 19
Low Surface Tension Food Grade Colored Fluid Formulations

| | SAMPLE LL | SAMPLE MM |
|---|---|---|
| Color | Blue (Cyan) | Blue (Cyan) |
| 1,2-propanediol | 90.27 | 89.90 |
| Glycerine | 4 | 3.98 |
| NaOH | 0.03 | 0.03 |
| Deionized Water | 2 | 2 |
| FD&C Blue 1 (low C1⁻, Table 1) | 1.6 | 1.59 |
| Isopropanol | 2 | 2 |
| Yelkin ® 1018 | 0.1 | 0.5 |
| Surface Tension (dynes/cm at 25° C.) | 39.5 | 33.2 |

### Example 31

### Preparation of Food Grade Colored Fluids

The following colored fluids were prepared:

TABLE 20
Food Grade Cyan Colored Fluid NN

| % | Ingredient |
|---|---|
| 90.36 | Propylene Glycol, USP/EP |
| 4.00 | Glycerine 99.7% USP/EP, OPTIM |
| 2.00 | Water, Deionized |
| 1.60 | FD&C Blue 1 IJG POWDER |
| 2.00 | Isopropyl Alcohol Angydrous, USP&Kosher |
| 0.04 | INT FOOD NaOH/WATER |

TABLE 21
Food Grade Cyan Colored Fluid PP

| % | Ingredient |
|---|---|
| 92.37 | Propylene Glycol, USP/EP |
| 4.00 | Glycerine 99.7% USP/EP, OPTIM |
| 2.00 | Water, Deionized |
| 1.60 | FD&C Blue 1 IJG POWDER |
| 0.03 | INT FOOD NaOH/WATER |

TABLE 22
Food Grade Magenta Colored Fluid QQ

| % | Ingredient |
|---|---|
| 89.59 | Propylene Glycol, USP/EP |
| 6.00 | Glycerine 99.7% USP/EP, OPTIM |
| 2.00 | Water, Deionized |
| 0.01 | FD&C Blue 1 IJG POWDER |
| 0.13 | FD&C Red 40 IJG |
| 2.07 | FD&C Red 3 1 IJG |

TABLE 23
Food Grade Magenta Colored Fluid RR

| % | Ingredient |
|---|---|
| 87.59 | Propylene Glycol, USP/EP |
| 6.00 | Glycerine 99.7% USP/EP, OPTIM |
| 4.00 | Water, Deionized |
| 0.01 | FD&C Blue 1 IJG POWDER |
| 0.13 | FD&C Red 40 IJG |
| 2.07 | FD&C Red 3 1 IJG |

TABLE 24
Food Grade Yellow Colored Fluid SS

| % | Ingredient |
|---|---|
| 91.7 | Propylene Glycol, USP/EP |
| 4.00 | Glycerine 99.7% USP/EP, OPTIM |
| 2.00 | Water, Deionized |
| 2.2 | FD&C Yellow No. 5 IJG |

TABLE 25
Food Grade Black Colored Fluid TT

| % | Ingredient |
|---|---|
| 62.61 | Propylene Glycol, USP/EP |
| 24.5 | Glycerine 99.7% USP/EP, OPTIM |
| 10.8 | Water, Deionized |
| 0.2 | FD&C Yellow 6 IJG |
| 0.1 | FD&C Red 3 IJG |
| 0.78 | FD&C Blue 1 IJG POWDER |
| 0.88 | FD&C Red No 40 IJG POWDER |
| 0.03 | 1.000 N NaOH |

TABLE 26
Food Grade Yellow Colored Fluid UU

| % | Ingredient |
|---|---|
| 89.22 | Propylene Glycol, USP/EP |
| 6.00 | Glycerine 99.7% USP/EP, OPTIM |
| 3.00 | Water, Deionized |
| 1.00 | FD&C Yellow No 5 IJG POWDER |
| 0.65 | FD&C Blue No 1 IJG POWDER |
| 0.03 | 1.0 N NaOH |

TABLE 27
Food Grade Blue Colored Fluid VV

| % | Ingredient |
|---|---|
| 89.00 | Propylene Glycol, USP/EP |
| 6.00 | Glycerine 99.7% USP/EP, OPTIM |
| 3.00 | Water, Deionized |
| 0.49 | FD&C Red No 3 IJG POWDER |
| 1.4 | FD&C Blue No 1 IJG POWDER |
| 0.01 | 1.0 N NaOH |

TABLE 28
Food Grade Magenta Colored Fluid WW

| % | Ingredient |
|---|---|
| 87.69 | Propylene Glycol, USP/EP |
| 6.00 | Glycerine 99.7% USP/EP, OPTIM |
| 2.00 | Water, Deionized |
| 0.01 | FD&C Blue 1 IJG POWDER |
| 0.13 | FD&C Red No 40 IJG POWDER |
| 2.07 | FD&C Red No 3 IJG POWDER |
| 2.00 | Isopropyl Alcohol Angydrous, USP&Kosher |

TABLE 29
Food Grade Cyan Colored Fluid XX

| % | Ingredient |
|---|---|
| 90.27 | Propylene Glycol, USP/EP |
| 4.00 | Glycerine 99.7% USP/EP, OPTIM |
| 2.00 | Water, Deionized |
| 0.65 | FD&C Blue No 1 IJG POWDER |
| 0.03 | 1.0 N NaOH |
| 2.00 | Isopropyl Alcohol Angydrous, USP&Kosher |

TABLE 30
Food Grade Yellow Colored Fluid YY

| % | Ingredient |
|---|---|
| 91.7 | Propylene Glycol, USP/EP |
| 4.00 | Glycerine 99.7% USP/EP, OPTIM |
| 0.00 | Water, Deionized |
| 2.2 | FD&C Yellow No 5 IJG POWDER |
| 2.00 | Isopropyl Alcohol Angydrous, USP&Kosher |

TABLE 31
Food Grade Black Colored Fluid ZZ

| % | Ingredient |
|---|---|
| 62.61 | Propylene Glycol, USP/EP |
| 24.5 | Glycerine 99.7% USP/EP, OPTIM |
| 8.8 | Water, Deionized |
| 0.2 | FD&C Yellow 6 IJG |
| 0.1 | FD&C Red 3 IJG |
| 0.78 | FD&C Blue 1 IJG POWDER |
| 0.88 | FD&C Red No 40 IJG POWDER |
| 0.03 | 1.000 N NaOH |
| 2.00 | Isopropyl Alcohol Angydrous, USP&Kosher |

The 1,2-propanediol and glycerine were mixed together in a container approved for food use at 50° C. for approximately 20 minutes. The FD&C dyes were then added while mixing, the heater was turned off and mixing continued for about one hour. The mixtures were allowed to cool to ambient temperature. Next, if included, the isopropanol was added, and the mixing continued for another ten minutes. The resulting colored fluids were then filtered with a 0.2 μm filter prior to use in Examples 14-31.

### Example 32

### Colored Fluids from Food Grade Colored Fluids and BYK®-333

This example describes a method for producing colored fluids from Food Grade Colored Fluids and BYK®-333. 0.4 g of BYK®-333 was added to 396.6 g of each of Food Grade Cyan Colored Fluid NN and Food Grade Cyan Colored Fluid PP. The fluids were mixed at 40° C. for 1 hour, then mixed and cooled to 30° C. The surface tension was 29.5 for the fluid prepared with Food Grade Cyan Colored Fluid NN and 29 for the fluid prepared with Food Grade Cyan Colored Fluid PP.

1.2 g or 4.2 g of BYK®-333 was added to 1198.8 g or 1195.8 g of Food Grade Cyan Colored Fluid PP respectively, to a final concentration of 0.1% or 0.35%. The fluid containing 0.1% BYK®-333 had a pH of 7.29, a viscosity of 48.3, a surface tension of 30.0, a specific gravity of 1.0541 and an absorbance at 629 nm (1/4000) of 0.703. The fluid containing 0.35% BYK®-333 had a pH of 6.5, a viscosity of 47.1, a surface tension of 26.2, a specific gravity of 1.0529 and an absorbance at 629 nm (1/4000) of 0.650.

0.1 g of BYK®-333 was added to 99.9 g of Food Grade Cyan Colored Fluid NN and mixed for 30 minutes. The colored fluid was printed with a piezo inkjet printhead.

0.2 g of BYK®-333 was added to 99.8 g of Food Grade Magenta Colored Fluid QQ and mixed for 1 hour. Some sludge was noted. The fluid had a pH of 7.78, a viscosity of 48.6, a surface tension of 38.0, a specific gravity of 1.06497 and an absorbance at 526 nm (1/2000) of 1.1441.

0.1 g of BYK®-333 was added to 99.9 g of Food Grade Magenta Colored Fluid RR and mixed for 1 hour. A dye residue line was noted. The fluid had a pH of 7.61, a viscosity of 46.0, a surface tension of 35.6, a specific gravity of 1.0662 and an absorbance at 526 nm (1/2000) of 1.163.

0.1 g of BYK®-333 was added to 99.9 g of Food Grade Yellow Colored Fluid SS and mixed for 1 hour. The fluid had a pH of 7.63, a viscosity of 49.6, a surface tension of 29.5, a specific gravity of 1.05983, and an absorbance at 426 nm (1/2000) of 0.56.

0.1 g of BYK®-333 was added to 99.9 g of Food Grade Black Colored Fluid TT and mixed for 1 hour. The fluid had a pH of 7.29, a viscosity of 46.6, a surface tension of 35.9, a specific gravity of 1.1010, and an absorbance at 629 mm (1/2000) of 0.647, at 575.7 mm (1/2000) of 0.3201, and at 409.1 nm of 0.156.

0.1 g of BYK®-333 was added to 99.9 g of Food Grade Yellow Colored Fluid UU and mixed for 1 hour. The fluid had a pH of 7.35, a viscosity of 48.9, a surface tension of 37.7, a specific gravity of 1.0589, and an absorbance at 629 nm (1/2000) of 0.538.

0.1 g of BYK®-333 was added to 99.9 g of Food Grade Blue Colored Fluid VV and mixed for 1 hour. The fluid had a pH of 7.13, a viscosity of 48.7, a surface tension of 27.3, a specific gravity of 1.0602, and an absorbance at 629 nm (1/4000) of 0.572.

0.1 g of BYK®-333 was added to 99.9 g of Food Grade Magenta Colored Fluid WW and mixed for 1 hour. The fluid had a pH of 7.38, a viscosity of 48.8, a surface tension of 32.9, a specific gravity of 1.0602, and an absorbance at 526.4 nm (1/2000) of 1.1291.

0.1 g of BYK®-333 was added to 99.9 g of Food Grade Cyan Colored Fluid XX and mixed for 45 minutes. The fluid had a pH of 6.79, a viscosity of 44.4, a surface tension of 34.6 and 29.9, a specific gravity of 1.04694, and an absorbance at 629.4 nm (1/4000) of 0.6497.

0.1 g of BYK®-333 was added to 99.9 g of Food Grade Yellow Colored Fluid YY and mixed for 1 hour. The fluid had a pH of 7.62, a viscosity of 54.2, a surface tension of 35.9 and 29.7, a specific gravity of 1.05055, and an absorbance at 426 nm (1/2000) of 0.5565.

1.6 g of BYK®-333 was added to 1.6 Liters of Food Grade Black Colored Fluid ZZ and mixed for 1 hour. The fluid had a pH of 7.22, a viscosity of 49.2, a surface tension of 32.9 and 31.6, and a specific gravity of 1.0938.

### Example 33

### Colored Fluids from FOOD GRADE CYAN COLORED FLUID PP and BYK®-020

This example describes a method for producing colored fluids from FOOD GRADE CYAN COLORED FLUID PP and BYK®-020. 0.1 g of BYK®-020 was added to 99.9 g of Food Grade Cyan Colored Fluid PP. The fluid was mixed at 38° C. for 1 hour, then mixed and cooled. The surface tension was 40.

### Example 34

### Colored Fluids from FOOD GRADE CYAN COLORED FLUID PP and BYK®-067A

This example describes a method for producing colored fluids from FOOD GRADE CYAN COLORED FLUID PP and BYK®-067A. 0.1 g of BYK®-067A was added to 99.9 g of Food Grade Cyan Colored Fluid PP. The fluid was mixed at 40° C. for 1 hour, then mixed and cooled to 30° C. The surface tension was 41.4.

0.5 g of BYK®-067A was added to 99.5 g of Food Grade Cyan Colored Fluid PP. The fluid was mixed at 40° C. for 1 hour, then mixed and cooled to 30° C. The surface tension was 41.3.

### Example 35

### Colored Fluids from FOOD GRADE CYAN COLORED FLUID PP and BYK®-080A

This example describes a method for producing colored fluids from FOOD GRADE CYAN COLORED FLUID PP and BYK®-080A. 0.1 g of BYK®-080A was added to 99.9 g of Food Grade Cyan Colored Fluid PP. The fluid was mixed at 40° C. for 1 hour, then mixed and cooled to 30° C. The surface tension was 41.3.

0.15 g of BYK®-080A was added to 99.85 g of Food Grade Cyan Colored Fluid PP. The fluid was mixed at 40° C. for 1 hour, then mixed and cooled to 30° C. The surface tension was 41.4.

### Example 36

### Colored Fluids from FOOD GRADE CYAN COLORED FLUID NN and PP and BYK®-308

This example describes a method for producing colored fluids from FOOD GRADE CYAN COLORED FLUID PP and BYK®-308. 0.1 g of BYK®-308 was added to 99.9 g of Food Grade Cyan Colored Fluid PP. The fluid was mixed at 40° C. for 1 hour, then mixed and cooled to 30° C. The surface tension was 34.2 at 30° C. and 38.0 at 25° C.

0.15 g of BYK®-308 was added to 99.85 g of Food Grade Cyan Colored Fluid PP. The fluid was mixed at 40° C. for 1 hour, then mixed and cooled to 30° C. The surface tension was 32.0.

0.15 g of BYK®-308 was added to 99.85 g of Food Grade Cyan Colored Fluid NN prior to the addition of the blue dye. The components were mixed for 10 minutes at 40° C. The blue dye was added and mixing continued for 1 hour at 40° C., then mixed and cooled to 30° C. and filtered through a 0.2 μm filter. Foam layer was noted at filtration. The surface tension was 37.0. Before filtration the surface tension was 32.3.

### Example 37

### Colored Fluids from FOOD GRADE CYAN COLORED FLUID PP and BYK®-1660

This example describes a method for producing colored fluids from FOOD GRADE CYAN COLORED FLUID PP and BYK®-1660. 0.1 g of BYK®-1660 was added to 99.9 g of Food Grade Cyan Colored Fluid PP. The fluid was mixed at 40° C. for 1 hour, then mixed and cooled to 30° C. The surface tension was 38.0.

0.05 g of BYK®-1660 was added to 99.95 g of Food Grade Cyan Colored Fluid PP. The fluid was mixed at 40° C. for 1 hour, then mixed and cooled to 30° C. The surface tension was 32.0.

### Example 38

### Colored Fluids from FOOD GRADE CYAN COLORED FLUID NN or FOOD GRADE CYAN COLORED FLUID PP and Foam Blast® 10

This example describes a method for producing colored fluids from FOOD GRADE CYAN COLORED FLUID NN or FOOD GRADE CYAN COLORED FLUID PP and Foam Blast® 10. 0.1 g of Foam Blast® 10 was added to 99.9 g of Food Grade Cyan Colored Fluid NN. The fluid was mixed at 40° C. for 1 hour, then mixed and cooled to 30° C. The surface tension was 36.0. 0.2 g of Foam Blast® 10 was added to 99.8 g of Food Grade Cyan Colored Fluid NN. The fluid was mixed at 40° C. for 1 hour, then mixed and cooled to 30° C.

0.15 g of Foam Blast® 10 was added to 99.85 g of Food Grade Cyan Colored Fluid PP. The fluid was mixed at 40° C. for 1 hour, then mixed and cooled to 30° C. The surface tension was 37.2.

### Example 39

### Colored Fluids from FOOD GRADE CYAN COLORED FLUID NN or PP and Masil® SF 350 FG

This example describes a method for producing colored fluids from FOOD GRADE CYAN COLORED FLUID NN or PP and Masil® SF 350 FG. 0.1 g of Masil® SF 350 FG was added to 99.9 g of Food Grade Cyan Colored Fluid NN. The fluid was mixed at 40° C. for 1 hour, then mixed and cooled to 30° C. The surface tension was 38.0.

0.2 g of Masil® SF 350 FG was added to 99.8 g of Food Grade Cyan Colored Fluid PP. The fluid was mixed at 40° C. for 1 hour, then mixed and cooled to 30° C. The surface tension was 35.3.

### Example 40

### Colored Fluids from FOOD GRADE CYAN COLORED FLUID PP and BYK®-024

This example describes a method for producing colored fluids from FOOD GRADE CYAN COLORED FLUID PP and BYK®-024. 0.1 g of BYK®-024 was added to 99.9 g of Food Grade Cyan Colored Fluid PP. The fluid was mixed at 40° C. for 1 hour, then mixed and cooled to 30° C. The surface tension was 29 or 26.4.

### Example 41

### Colored Fluids from FOOD GRADE CYAN COLORED FLUID PP and BYK®-085

This example describes a method for producing colored fluids from FOOD GRADE CYAN COLORED FLUID PP and BYK®-085. 0.1 g of BYK®-085 was added to 99.9 g of Food Grade Cyan Colored Fluid PP. The fluid was mixed at 40° C. for 1 hour, then mixed and cooled to 30° C. The surface tension was 36.3.

### Example 42

### Colored Fluids from FOOD GRADE CYAN COLORED FLUID PP and BYK®-323

This example describes a method for producing colored fluids from FOOD GRADE CYAN COLORED FLUID PP and BYK®-323. 0.1 g of BYK®-323 was added to 99.9 g of Food Grade Cyan Colored Fluid PP. The fluid was mixed at 40° C. for 1 hour, then mixed and cooled to 30° C. The surface tension was 37.5.

### Example 43

### Colored Fluids from FOOD GRADE CYAN COLORED FLUID PP and Masil® SF-19

This example describes a method for producing colored fluids from FOOD GRADE CYAN COLORED FLUID PP and Masil® SF-19. 0.1 g of Masil® SF-19 was added to 99.9 g of Food Grade Cyan Colored Fluid PP. The fluid was mixed at 40° C. for 1 hour, then mixed and cooled to 30° C. The surface tension was 37.0.

0.2 g of Masil® SF-19 was added to 99.8 g of Food Grade Cyan Colored Fluid PP. The fluid was mixed at 40° C. for 1 hour, then mixed and cooled to 30° C. The surface tension was 38.2.

### Example 44

### Colored Fluids from FOOD GRADE CYAN COLORED FLUID PP and SF18-350

This example describes a method for producing colored fluids from FOOD GRADE CYAN COLORED FLUID PP and SF18-350 (commercially available from GE) hour, then mixed and cooled to 30° C. The surface tension was 37.0.

### Example 45

### Colored Fluids from FOOD GRADE CYAN COLORED FLUID NN or PP and BYK®-310

This example describes a method for producing colored fluids from FOOD GRADE CYAN COLORED FLUID NN or PP and BYK®-310. 0.1 g of BYK®-310 was added to 99.9 g of Food Grade Cyan Colored Fluid NN. The fluid was mixed at 40° C. for 1 hour, then mixed and cooled to 30° C. The surface tension was 39.0. The pH was 6.72, the viscosity was 45.4 cps, the specific gravity was 1.0474, and the absorbance at 629 nm (1/4000) was 0.0511.

0.1 g of BYK®-310 was added to 99.9 g of Food Grade Cyan Colored Fluid PP. The fluid was mixed at 40° C. for 1 hour, then mixed and cooled to 30° C. The surface tension was 30.5.

### Example 46

### Colored Fluids from FOOD GRADE CYAN COLORED FLUID PP and BYK®-346

This example describes a method for producing colored fluids from FOOD GRADE CYAN COLORED FLUID PP and BYK®-346. 0.1 g of BYK®-346 was added to 99.9 g of Food Grade Cyan Colored Fluid PP. The fluid was mixed at 40° C. for 1 hour, then mixed and cooled to 30° C. The surface tension was 37.3.

### Example 47

### Colored Fluids from FOOD GRADE CYAN COLORED FLUID PP and BYK®-301

This example describes a method for producing colored fluids from FOOD GRADE CYAN COLORED FLUID PP and BYK®-301. 0.1 g of BYK®-301 was added to 99.9 g of Food Grade Cyan Colored Fluid PP. The fluid was mixed at 40° C. for 1 hour, then mixed and cooled to 30° C. The surface tension was 36.5.

### Example 48

### Colored Fluids from FOOD GRADE CYAN COLORED FLUID PP and Dehydran® 1620

This example describes a method for producing colored fluids from FOOD GRADE CYAN COLORED FLUID PP and Dehydran® 1620. 0.1 g of Dehydran® 1620 was added to 99.9 g of Food Grade Cyan Colored Fluid PP. The fluid was mixed at 40° C. for 1 hour, then mixed and cooled to 30° C. The surface tension was 38.3.

### Example 49

### Colored Fluids from FOOD GRADE CYAN COLORED FLUID PP and Dehydran® 2620

This example describes a method for producing colored fluids from FOOD GRADE CYAN COLORED FLUID PP and Dehydran® 2620. 0.1 g of Dehydran® 1620 was added to 99.9 g of Food Grade Cyan Colored Fluid PP. The fluid was mixed at 40° C. for 1 hour, then mixed and cooled to 30° C. The surface tension was 32.4.

The invention has been described with reference to very specific and illustrative embodiments. However, it should be understood that many variations and modifications may be made while remaining within the spirit and scope of the invention.

What is claimed is:

1. A method of imparting flavor to an edible substrate comprising precision depositing a first food grade flavored fluid onto a surface of an edible substrate.

2. The method of claim 1, further comprising precision depositing a second food grade flavored fluid onto the substrate, the second food grade flavored fluid having a different flavor than the first food grade flavored fluid.

3. The method of claim 1, wherein the edible substrate has a flavor which is the same as the first food grade flavored fluid, and applying the first food grade flavored fluid onto the edible substrate intensifies the flavor of the edible substrate.

4. The method of claim 1, wherein the edible substrate has a flavor different from the first food grade flavored fluid.

5. The method of claim 1, wherein the first food grade flavored fluid comprises a food grade flavor and a food grade glycol.

6. The method of claim 1, wherein the precision deposition applies the food grade flavored fluid in a round shape having a diameter of about 1/16″ to about 2″, in a stripe having a width of about ⅛″ to about 2″, or combinations thereof.

7. The method of claim 1, wherein the precision deposition applies the food grade flavored fluid using spot marking.

8. The method of claim 1, wherein the first food grade flavored fluid is applied onto the surface of the edible substrate using precision deposition to form an image.

9. The method of claim 8, wherein the food grade flavor correlates with the image.

10. The method of claim 8, wherein the food grade flavor does not correlate with the image.

11. The method of claim 1, further comprising ink jet printing a food grade colored fluid onto the substrate to form an image.

12. The method of claim 11, wherein the food grade colored fluid comprises a food grade dye, glycerine, at least about 25 wt. % 1,2-propanediol, and a surface tension modifier selected from the group consisting of sorbitan esters, fatty acids, polyol esters of fatty acids, lecithins and mixtures thereof; wherein the 1,2-propanediol, glycerine and any optional water make up at least about 90 wt. % of the colored fluid, and any water present makes up no more than about 35 wt. % of the colored fluid.

13. The method of claim 11, wherein the food grade colored fluid comprises food grade dye, about 25 to 95 wt. % 1,2-propanediol, about 1 to 50 wt. % glycerine, about 0.01 to 5 wt. % surface tension modifier selected from the group consisting of sorbitan esters, fatty acids, mixtures of fatty acids, and esters of fatty acids, and no more than about 10 wt. % water; wherein the colored fluid has a surface tension of no more than about 38 dynes per cm at 25° C.

14. The method of claim 11, wherein the food grade colored fluid comprises food grade dye, food grade glycol, glycerine, and a surface tension modifier selected from the group consisting of sorbitan esters, fatty acids, polyol esters of fatty acids, and mixtures thereof; wherein the food grade glycol, glycerine and any optional water make up at least about 90 wt. % of the colored fluid; and any water present makes up no more than about 10 wt. % of the colored fluid; and further wherein the colored fluid has a surface tension of no more than about 38 dynes per cm at 25° C.

15. The method of claim 11, wherein the food grade colored fluid comprises food grade dye, at least about 50 wt. % 1,2-propanediol, and a surface tension modifier selected from the group consisting of sorbitan esters, fatty acids, mixtures of fatty acids, and esters of fatty acids; wherein the food grade dye has an inorganic salt content of no more than about 0.1 wt. %.

16. The method of claim 11, wherein the food grade colored fluid comprises food grade dye, no more than about 10 wt. % water, a surface tension modifier selected from the group consisting of sorbitan esters, fatty acids, mixtures of fatty acids, and esters of fatty acids, and lecithins; and at least about 70 wt. % 1,2-propanediol, glycerine or a mixture thereof.

17. The method of claim 11, wherein the food grade colored fluid comprises food grade dye; a surface tension modifier selected from the group consisting of sorbitan esters, fatty acids, polyol monoesters and esters of fatty acids, mixtures of fatty acids, lecithins and mixtures thereof; and at least about 70 wt. % 1,2-propanediol, glycerine or a mixture thereof and comprising at least about 10% 1,2-propanediol.

18. The method of claim 11, wherein the food grade flavor correlates with the image.

19. The method of claim 11, wherein the food grade flavor does not correlate with the image.

20. A method of providing a flavored image on an edible substrate, the method comprising:
ink jet printing a food grade colored fluid comprising a food grade dye, a food grade glycol, and a surface tension modifier to create an image; and
spraying a food grade flavored fluid onto the edible substrate.

21. The method of claim 20, wherein the food grade glycol comprises 1,2-propanediol.

22. The method of claim 20, wherein spraying comprises precision depositing the flavored fluid.

23. The method of claim 20, wherein precision depositing comprises applying the food grade flavored fluid in a round shape having a diameter of about 1/16″ to about 2″, in a stripe having a width of about ⅛″ to about 2″, or combinations thereof.

24. The method of claim 20, wherein precision depositing comprises applying the food grade flavored fluid using spot marking.

25. The method of claim 20, wherein the flavored fluid comprises a food grade flavor and a food grade glycol.

26. The method of claim 20, wherein the colored fluid correlates with the flavored fluid.

27. The method of claim 20, wherein the colored fluid does not correlate with the flavored fluid.

28. The method of claim 20, wherein the colored fluid correlates with the substrate.

29. The method of claim 20, wherein the colored fluid does not correlate with the substrate.

30. The method of claim 20, wherein the flavored fluid correlates with the substrate.

31. The method of claim 20, wherein the flavored fluid does not correlate with the substrate.

32. The method of claim 20, wherein the food grade colored fluid comprises a food grade dye, glycerine, at least about 25 wt. % 1,2-propanediol, and a surface tension modifier selected from the group consisting of sorbitan esters, fatty acids, polyol esters of fatty acids, lecithins and mixtures thereof; wherein the 1,2-propanediol, glycerine and any optional water make up at least about 90 wt. % of the colored fluid, and any water present makes up no more than about 35 wt. % of the colored fluid.

33. The method of claim 20, wherein the food grade colored fluid comprises food grade dye, about 25 to 95 wt. % 1,2-propanediol, about 1 to 50 wt. % glycerine, about 0.01 to 5 wt. % surface tension modifier selected from the group consisting of sorbitan esters, fatty acids, mixtures of fatty acids, and esters of fatty acids, and no more than about 10 wt. % water; wherein the colored fluid has a surface tension of no more than about 38 dynes per cm at 25° C.

34. The method of claim 20, wherein the food grade colored fluid comprises food grade dye, food grade glycol, glycerine, and a surface tension modifier selected from the group consisting of sorbitan esters, fatty acids, polyol esters of fatty acids, and mixtures thereof; wherein the food grade glycol, glycerine and any optional water make up at least about 90 wt. % of the colored fluid; and any water present makes up no more than about 10 wt. % of the colored fluid; and further wherein the colored fluid has a surface tension of no more than about 38 dynes per cm at 25° C.

35. The method of claim 20, wherein the food grade colored fluid comprises food grade dye, at least about 50 wt. % 1,2-propanediol, and a surface tension modifier selected from the group consisting of sorbitan esters, fatty acids, mixtures of fatty acids, and esters of fatty acids; wherein the food grade dye has an inorganic salt content of no more than about 0.1 wt. %.

36. The method of claim 20, wherein the food grade colored fluid comprises food grade dye, no more than about 10 wt. % water, a surface tension modifier selected from the group consisting of sorbitan esters, fatty acids, mixtures of fatty acids, and esters of fatty acids, and lecithins; and at least about 70 wt. % 1,2-propanediol, glycerine or a mixture thereof.

37. The method of claim 20, wherein the food grade colored fluid comprises food grade dye; a surface tension modifier selected from the group consisting of sorbitan esters, fatty acids, polyol monoesters and esters of fatty acids, mixtures of fatty acids, lecithins and mixtures thereof; and at least about 70 wt. % 1,2-propanediol, glycerine or a mixture thereof and comprising at least about 10% 1,2-propanediol.

38. A method of providing a flavored image on an edible substrate, the method comprising:
ink jet printing a food grade colored fluid to create an image; and
spraying a food grade flavored fluid comprising a food grade flavor and a food grade glycol onto the edible substrate.
